(19) United States
(12) Patent Application Publication
(10) Pub. No.: US 2021/0289213 A1
(43) Pub. Date: Sep. 16, 2021

(54) METHOD AND APPARATUS FOR TILE AND SLICING MAPPING

(71) Applicant: ALIBABA GROUP HOLDING LIMITED, George Town (KY)

(72) Inventors: Jiancong LUO, Skillman, NJ (US); Jie CHEN, Beijing (CN); Yan YE, San Diego, CA (US)

(21) Appl. No.: 17/198,588

(22) Filed: Mar. 11, 2021

Related U.S. Application Data
(60) Provisional application No. 62/988,416, filed on Mar. 12, 2020.

(51) Int. Cl. H04N 19/174; H04N 19/176; H04N 19/96

(52) U.S. Cl. CPC H04N 19/174; H04N 19/96; H04N 19/176

(57) ABSTRACT

Methods and apparatuses for video processing include: in response to receiving a picture and a tile, determining, based on a parameter set associated with the picture, whether the tile includes a block outside the picture; based on a determination that the tile includes the block outside the picture, disregarding the block from a list of blocks associated with the picture; and encoding or decoding the list of blocks associated with the picture.

### CROSS-REFERENCE TO RELATED APPLICATIONS

The present disclosure claims priority to U.S. provisional application No. 62/988,416, filed on Mar. 12, 2020, the content of which is incorporated herein by reference in its entirety.

### TECHNICAL FIELD

The present disclosure generally relates to video processing, and more particularly, to methods and apparatuses for performing tile and slice mapping.

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transform, quantization, entropy coding and in-loop filtering. The video coding standards, such as the High Efficiency Video Coding (e.g., HEVC/H.265) standard, the Versatile Video Coding (e.g., VVC/H.266) standard, and AVS standards, specifying the specific video coding formats, are developed by standardization organizations. With more and more advanced video coding technologies being adopted in the video standards, the coding efficiency of the new video coding standards get higher and higher.

### SUMMARY OF THE DISCLOSURE

The embodiments of present disclosure provide methods and apparatuses for video processing. In an aspect, a non-transitory computer-readable medium is provided, which stores a set of instructions that is executable by at least one processor of an apparatus to cause the apparatus to perform a method. The method includes: in response to receiving a picture and a tile, determining, based on a parameter set associated with the picture, whether the tile includes a. block outside the picture; based on a determination that the tile includes the block outside the picture, disregarding the block from a list of blocks associated with the picture; and encoding or decoding the list of blocks associated with the picture.

In another aspect, an apparatus for video processing is provided. The apparatus includes a memory configured to store a set of instructions and one or more processors communicatively coupled to the memory and configured to execute the set of instructions to cause the apparatus to perform: in response to receiving a picture and a tile, determining, based on a parameter set associated with the picture, whether the tile includes a block outside the picture; based on a determination that the tile includes the block outside the picture, disregarding the block from a list of blocks associated with the picture; and encoding or decoding the list of blocks associated with the picture.

In another example embodiment, a computer-implemented method is provided. The method includes: in response to receiving a picture and a tile, determining, based on a parameter set associated with the picture, whether the tile includes a block outside the picture; based on a determination that the tile includes the block outside the picture, disregarding the block from a list of blocks associated with the picture; and encoding or decoding the list of blocks associated with the picture.

### BRIEF DESCRIPTION OF THE DRAWINGS

Embodiments and various aspects of present disclosure are illustrated in the following detailed description and the accompanying figures. Various features shown in the figures are not drawn to scale.

FIG. 1 is a schematic diagram illustrating structures of an example video sequence, according to some embodiments of the present disclosure.

FIG. 2A illustrates a schematic diagram of an example encoding process of a hybrid video coding system, consistent with embodiments of the disclosure.

FIG. 2B illustrates a schematic diagram of another example encoding process of a hybrid video coding system, consistent with embodiments of the disclosure.

FIG. 3A illustrates a schematic diagram of an example decoding process of a hybrid video coding system, consistent with embodiments of the disclosure.

FIG. 3B illustrates a schematic diagram of another example decoding process of a hybrid video coding system, consistent with embodiments of the disclosure.

FIG. 4 illustrates a block diagram of an example apparatus for encoding or decoding a video, according to some embodiments of the present disclosure.

FIG. 5 is a schematic diagram illustrating structures of an example picture partitioned into blocks, consistent with some embodiments of the disclosure.

FIG. 6 is a schematic diagram illustrating structures of an example picture partitioned in a raster-scan slice mode, consistent with some embodiments of the disclosure.

FIG. 7 is a schematic diagram illustrating structures of an example picture partitioned in a rectangular slice mode, consistent with some embodiments of the disclosure.

FIG. 8 is a schematic diagram illustrating structures of another example picture partitioned in a rectangular slice mode, consistent with some embodiments of the disclosure.

FIG. 9 illustrates a table of example picture parameter set (PPS) syntax for signaling tile mapping and slices in tile mapping, consistent with some embodiments of the disclosure.

FIG. 10 illustrates a table of example syntax for deriving slice-related variables in the table of FIG. 9, consistent with some embodiments of the disclosure.

FIG. 11 illustrates a table of example syntax for deriving column-related variables in the table of FIG. 9, consistent with some embodiments of the disclosure.

FIG. 12 illustrates a table of example syntax for deriving row-related variables in the table of FIG. 9, consistent with some embodiments of the disclosure.

FIG. 13 illustrates a table of example syntax for deriving a column-related variable, consistent with some embodiments of the disclosure.

FIG. 14 illustrates a table of example syntax for deriving a row-related variable, consistent with some embodiments of the disclosure.

FIG. 15 illustrates a table of example syntax for deriving another column-related variable, consistent with some embodiments of the disclosure.

FIG. 16 illustrates a table of example syntax for deriving another row-related variable, consistent with some embodiments of the disclosure.

FIG. 17 illustrates a table of example syntax for deriving other slice-related variables, consistent with some embodiments of the disclosure.

FIG. 18 illustrates a table of example syntax for specifying a function in the table of FIG. 17, consistent with some embodiments of the disclosure.

FIG. 19 illustrates an example tile map of a picture, consistent with some embodiments of the disclosure.

FIG. 20 illustrates a table of example syntax values for signaling a tile map of a picture, consistent with some embodiments of the disclosure.

FIG. 21 illustrates another example tile map of a picture, consistent with some embodiments of the disclosure.

FIG. 22 illustrates another table of example syntax values for signaling a tile map of a picture, consistent with some embodiments of the disclosure.

FIG. 23 illustrates a table of example modified syntax for deriving column-related variables in the table of FIG. 9, consistent with some embodiments of the disclosure.

FIG. 24 illustrates a table of example modified syntax for deriving row-related variables in the table of FIG. 9, consistent with some embodiments of the disclosure.

FIG. 25 illustrates a table of example modified syntax for deriving slice-related variables in the table of FIG. 9, consistent with some embodiments of the disclosure.

FIG. 26 illustrates a table of another example modified syntax for deriving column-related variables in the table of FIG. 9, consistent with some embodiments of the disclosure.

FIG. 27 illustrates a table of another example modified syntax for deriving row-related variables in the table of FIG. 9, consistent with some embodiments of the disclosure.

FIG. 28 illustrates a table of another example modified syntax for deriving slice-related variables in the table of FIG. 9, consistent with some embodiments of the disclosure.

FIG. 29 illustrates a flowchart of an example process for video processing, according to some embodiments of this disclosure.

### DETAILED DESCRIPTION

Reference can now be made in detail to example embodiments, examples of which are illustrated in the accompanying drawings. The following description refers to the accompanying drawings in which the same numbers in different drawings represent the same or similar elements unless otherwise represented. The implementations set forth in the following description of example embodiments do not represent all implementations consistent with the invention. Instead, they are merely examples of apparatuses and methods consistent with aspects related to the invention as recited in the appended claims. Particular aspects of present disclosure are described in greater detail below. The terms and definitions provided herein control, if in conflict with terms aid/or definitions incorporated by reference.

The Joint Video Experts Team (JVET) of the ITU-T Video Coding Expert Group (ITU-T VCEG) and the ISO/IEC Moving Picture Expert Group (ISO/IEC MPEG) is currently developing the Versatile Video Coding (VVC/H.266) standard. The VVC standard is aimed at doubling the compression efficiency of its predecessor, the High Efficiency Video Coding (HEVC/H.265) standard. In other words, VVC's goal is to achieve the same subjective quality as HEVC/H.265 using half the bandwidth.

In order to achieve the same subjective quality as HEVC/H.265 using half the bandwidth, the JVET has been developing technologies beyond HEVC using the joint exploration model (JEM) reference software. As coding technologies were incorporated into the JEM, the JEM achieved substantially higher coding performance than HEVC.

The VVC standard has been developed recently and continues to include more coding technologies that provide better compression performance. VVC is based on the same hybrid video coding system that has been used in modern video compression standards such as HEVC, H.264/AVC, MPEG2, H.263, etc.

A video is a set of static pictures (or “frames”) arranged in a temporal sequence to store visual information. A video capture device (e.g., a camera) can be used to capture and store those pictures in a temporal sequence, and a video playback device (e.g., a television, a computer, a smartphone, a tablet computer, a video player, or any end-user terminal with a function of display) can be used to display such pictures in the temporal sequence. Also, in some applications, a video capturing device can transmit the captured video to the video playback device (e.g., a computer with a monitor) in real-time, such as for surveillance, conferencing, or live broadcasting.

For reducing the storage space and the transmission bandwidth needed by such applications, the video can be compressed before storage and transmission and decompressed before the display. The compression and decompression can be implemented by software executed by a processor (e.g., a processor of a generic computer) or specialized hardware. The module for compression is generally referred to as an “encoder,” and the module for decompression is generally referred to as a “decoder.” The encoder and decoder can be collectively referred to as a “codec.” The encoder and decoder can be implemented as any of a variety of suitable hardware, software, or a combination thereof. For example, the hardware implementation of the encoder and decoder can include circuitry, such as one or more microprocessors, digital signal processors (DSPs), application-specific integrated circuits (ASICs), field-programmable gate arrays (FPGAs), discrete logic, or any combinations thereof. The software implementation of the encoder and decoder can include program codes, computer-executable instructions, firmware, or any suitable computer-implemented algorithm or process fixed in a computer-readable medium. Video compression and decompression can be implemented by various algorithms or standards, such as MPEG-1, MPEG-2, MPEG-4, H.26x series, or the like. In some applications, the codec can decompress the video from a first coding standard and re-compress the decompressed video using a second coding standard, in which case the codec can be referred to as a “transcoder.”

The video encoding process can identify and keep useful information that can be used to reconstruct a picture and disregard unimportant information for the reconstruction. If the disregarded, unimportant information cannot be fully reconstructed, such an encoding process can be referred to as “lossy.” Otherwise, it can be referred to as “lossless.” Most encoding processes are lossy, which is a tradeoff to reduce the needed storage space and the transmission bandwidth.

The useful information of a picture being encoded (referred to as a “current picture” or “target picture”) include changes with respect to a reference picture (e.g., a picture previously encoded and reconstructed). Such changes can include position changes, luminosity changes, or color changes of the pixels, among which the position changes are mostly concerned. Position changes of a group of pixels that represent an object can reflect the motion of the object between the reference picture and the target picture.

A picture coded without referencing another picture (i.e., it is its own reference picture) is referred to as an “I-picture.” A picture is referred to as a “P-picture” if some or all blocks (e.g., blocks that generally refer to portions of the video picture) in the picture are predicted using intra prediction or inter prediction with one reference picture (e.g., uni-prediction). A picture is referred to as a “B-picture” if at least one block in it is predicted with two reference pictures (e.g., bi-prediction).

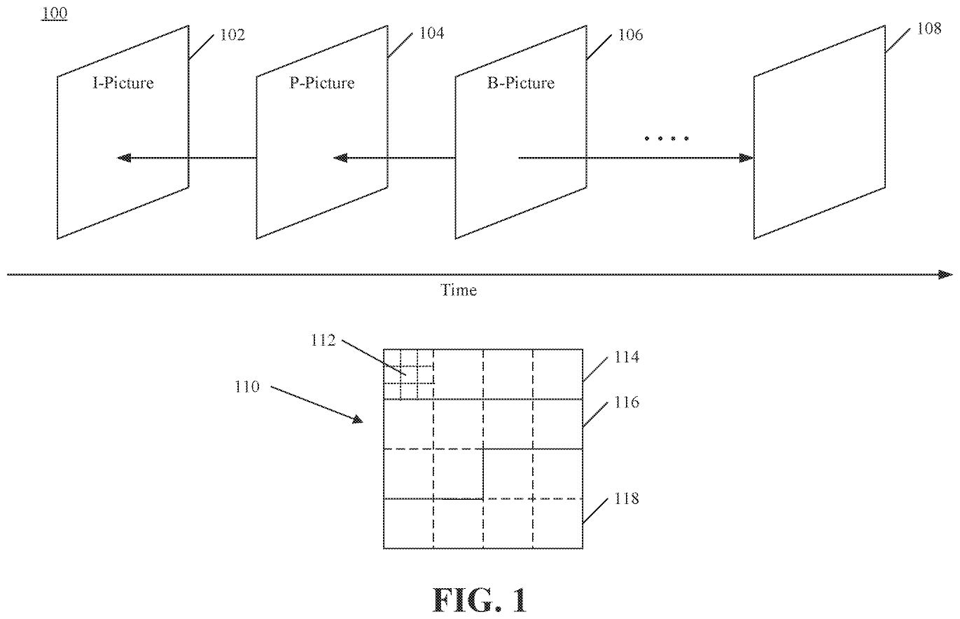

FIG. 1 illustrates structures of an example video sequence 100, according to some embodiments of the present disclosure. Video sequence 100 can be a live video or a video having been captured and archived. Video 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider.

As shown in FIG. 1, video sequence 100 can include a series of pictures arranged temporally along a timeline, including pictures 102, 104, 106, and 108. Pictures 102-106 are continuous, and there are more pictures between pictures 106 and 108. In FIG. 1, picture 102 is an I-picture, the reference picture of which is picture 102 itself. Picture 104 is a P-picture, the reference picture of which is picture 102, as indicated by the arrow. Picture 106 is a B-picture, the reference pictures of which are pictures 104 and 108, as indicated by the arrows. In some embodiments, the reference picture of a picture (e.g., picture 104) can be not immediately preceding or following the picture. For example, the reference picture of picture 104 can be a picture preceding picture 102. It should be noted that the reference pictures of pictures 102-106 are only examples, and the present disclosure does not limit embodiments of the reference pictures as the examples shown in FIG. 1.

Typically, video codecs do not encode or decode an entire picture at one time due to the computing complexity of such tasks. Rather, they can split the picture into basic segments, and encode or decode the picture segment by segment. Such basic segments are referred to as basic processing units (“BPUs”) in the present disclosure. For example, structure 110 in FIG. 1 shows an example structure of a picture of video sequence 100 (e.g., any of pictures 102-108). In structure 110, a picture is divided into 4×4 basic processing units, the boundaries of which are shown as dash lines. In some embodiments, the basic processing units can be referred to as “macroblocks” in some video coding standards (e.g., MPEG family, H.261, H.263, or H.264/AVC), or as “coding tree units” (“CTUs”) in some other video coding standards (e.g., H.265/HEVC or H.266/VVC). The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards (e.g., H.265/HEVC or H.266/VVC). Any operation performed to a basic processing unit can be repeatedly performed to each of its luma and chroma components.

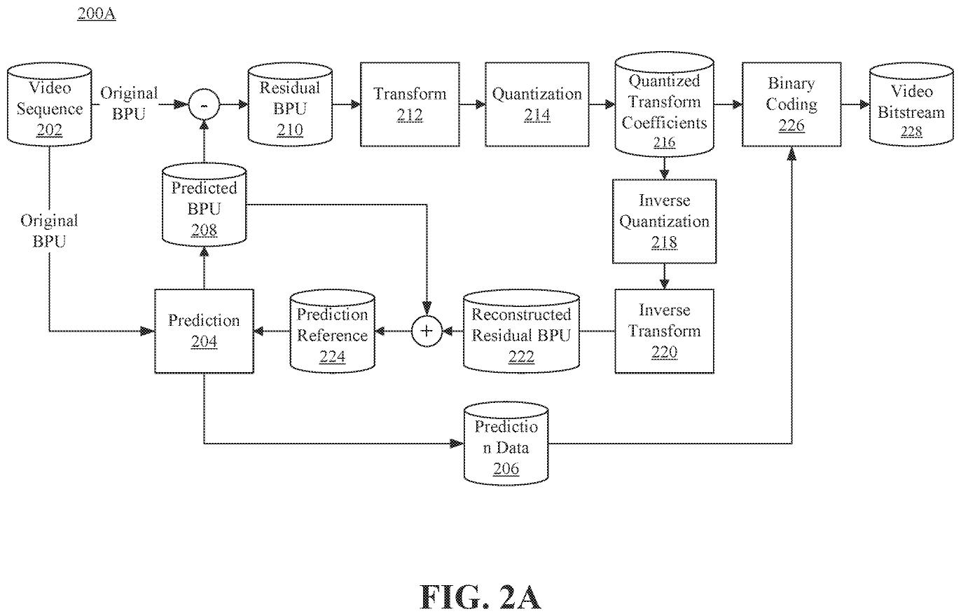

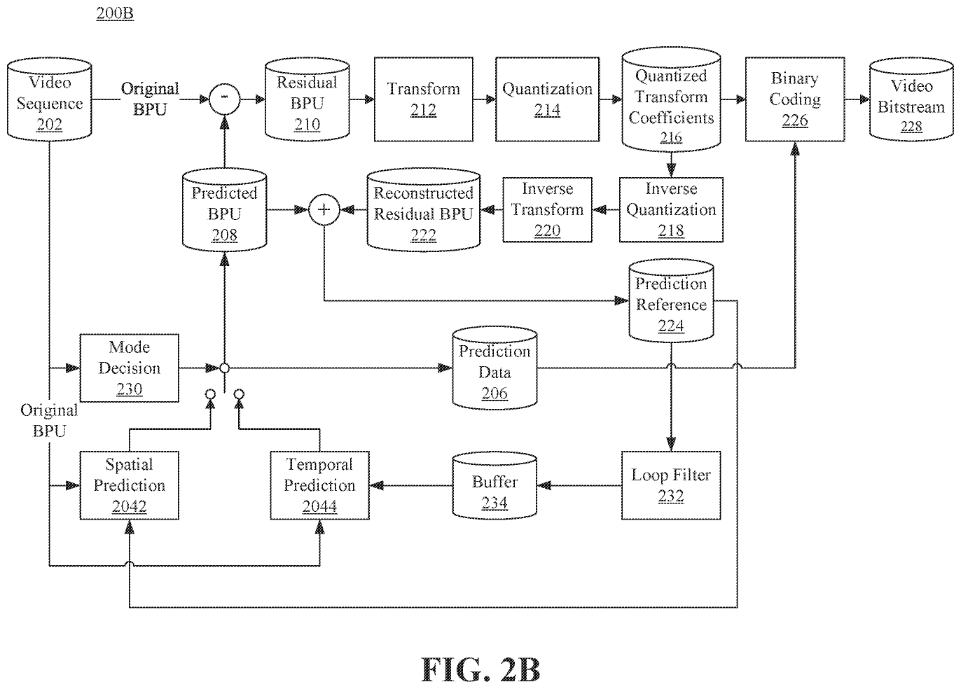

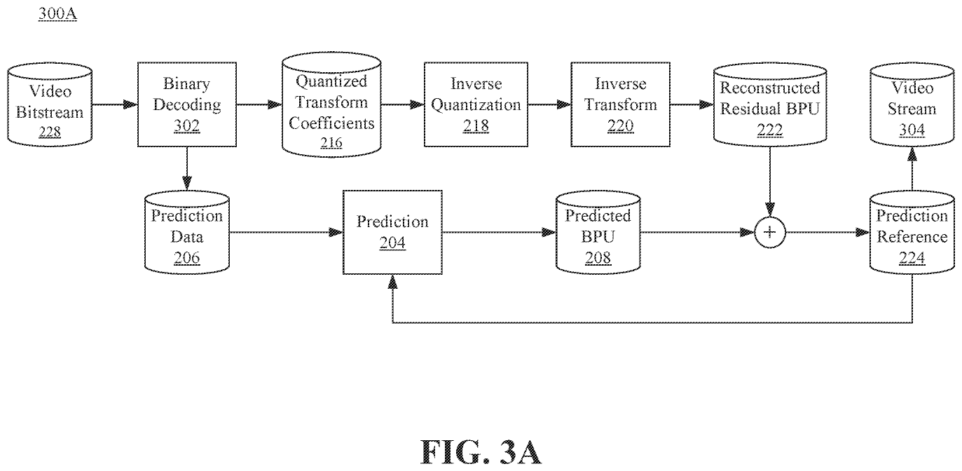

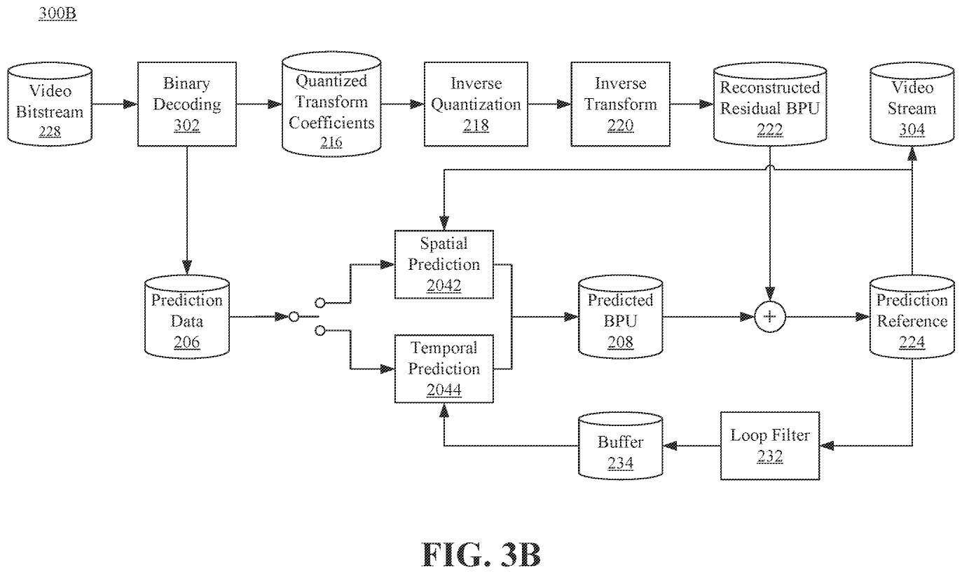

Video coding has multiple stages of operations, examples of which are shown in FIGS. 2A-2B and FIGS. 3A-3B. For each stage, the size of the basic processing units can still be too large for processing, and thus can be further divided into segments referred to as “basic processing sub-units” in the present disclosure. In some embodiments, the basic processing sub-units can be referred to as “blocks” in some video coding standards (e.g., MPEG family, H.261, H.263, or H.264/AVC), or as “coding units” (“CUs”) in some other video coding standards (e.g., H.265/HEVC or H.266/VVC). A basic processing sub-unit can have the same or smaller size than the basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Any operation performed to a basic processing sub-unit can be repeatedly performed to each of its luma and chroma components. It should be noted that such division can be performed to further levels depending on processing needs, It should also be noted that different stages can divide the basic processing units using different schemes.

For example, at a mode decision stage (an example of which is shown in FIG. 2B), the encoder can decide what prediction mode (e.g., intra-picture prediction or inter-picture prediction) to use for a basic processing unit, which can be too large to make such a decision. The encoder can split the basic processing unit into multiple basic processing sub-units (e.g., CUs as in H.265/HEVC or H.266/VVC), and decide a prediction type for each individual basic processing sub-unit.

For another example, at a prediction stage (an example of which is shown in FIGS. 2A-2B), the encoder can perform prediction operation at the level of basic processing sub-units (e.g., CUs). However, in some cases, a basic processing sub-unit can still be too large to process. The encoder can further split the basic processing sub-unit into smaller segments (e.g., referred to as “prediction blocks” or “PBs” in H.265/HEVC or H.266/VVC), at the level of which the prediction operation can be performed.

For another example, at a transform stage (an example of which is shown in FIGS. 2A-2B), the encoder can perform a transform operation for residual basic processing sub-units (e.g., CUs). However, in some cases, a basic processing sub-unit can still be too large to process. The encoder can further split the basic processing sub-unit into smaller segments (e.g., referred to as “transform blocks” or “TBs” in H.265/HEVC or H.266/VVC), at the level of which the transform operation can be performed. It should be noted that the division schemes of the same basic processing sub-unit can be different at the prediction stage and the transform stage. For example, in H.265/HEVC or H.266/VVC, the prediction blocks and transform blocks of the same CU can have different sizes and numbers.

In structure 110 of FIG. 1, basic processing unit 112 is further divided into 3×3 basic processing sub-units, the boundaries of which are shown as dotted lines. Different basic processing units of the same picture can be divided into basic processing sub-units in different schemes.

In some implementations, to provide the capability of parallel processing and error resilience to video encoding and decoding, a picture can be divided into regions for processing, such that, for a region of the picture, the encoding or decoding process can depend on no information from any other region of the picture. In other words, each region of the picture can be processed independently. By doing so, the codec can process different regions of a picture in parallel, thus increasing the coding efficiency. Also, when data of a region is corrupted in the processing or lost in network transmission, the codec can correctly encode or decode other regions of the same picture without reliance on the corrupted or lost data, thus providing the capability of error resilience. In some video coding standards, a picture can be divided into different types of regions. For example, H.265/HEVC and H.266/VVC provide two types of regions: “slices” and “tiles.” It should also be noted that different pictures of video sequence 100 can have different partition schemes for dividing a picture into regions.

For example, in FIG. 1, structure 110 is divided into three regions 114, 116, and 118, the boundaries of which are shown as solid lines inside structure 110. Region 114 includes four basic processing units. Each of regions 116 and 118 includes six basic processing units. It should be noted that the basic processing units, basic processing sub-units, and regions of structure 110 in FIG. 1 are only examples, and the present disclosure does not limit embodiments thereof.

FIG. 2A illustrates a schematic diagram of an example encoding process 200A, consistent with embodiments of the disclosure. For example, the encoding process 200A can be performed by an encoder. As shown in FIG. 2A, the encoder can encode video sequence 202 into video bitstream 228 according to process 200A. Similar to video sequence 100 in FIG. 1, video sequence 202 can include a set of pictures (referred to as “original pictures”) arranged in a temporal order. Similar to structure 110 in FIG. 1, each original picture of video sequence 202 can be divided by the encoder into basic processing units, basic processing sub-units, or regions for processing. In some embodiments, the encoder can perform process 200A at the level of basic processing units for each original picture of video sequence 202. For example, the encoder can perform process 200A in an iterative manner, in which the encoder can encode a basic processing unit in one iteration of process 200A. In some embodiments, the encoder can perform process 200A in parallel for regions (e.g., regions 114-118) of each original picture of video sequence 202.

In FIG. 2A, the encoder can feed a basic processing unit (referred to as an “original BPU”) of an original picture of video sequence 202 to prediction stage 204 to generate prediction data 206 and predicted BPU 208. The encoder can subtract predicted BPU 208 from the original BPU to generate residual BPU 210. The encoder can feed residual BPU 210 to transform stage 212 and quantization stage 214 to generate quantized transform coefficients 216. The encoder can feed prediction data 206 and quantized transform coefficients 216 to binary coding stage 226 to generate video bitstream 228. Components 202, 204, 206, 208, 210, 212, 214, 216, 226, and 228 can be referred to as a “forward path.” During process 200A, after quantization stage 214, the encoder can feed quantized transform coefficients 216 to inverse quantization stage 218 and inverse transform stage 220 to generate reconstructed residual BPU 222. The encoder can add reconstructed residual BPU 222 to predicted BPU 208 to generate prediction reference 224, which is used in prediction stage 204 for the next iteration of process 200A. Components 218, 220, 222, and 224 of process 200A can be referred to as a “reconstruction path.” The reconstruction path can be used to ensure that both the encoder and the decoder use the same reference data for prediction.

The encoder can perform process 200A iteratively to encode each original BPU of the original picture (in the forward path) and generate predicted reference 224 for encoding the next original BPU of the original picture (in the reconstruction path). After encoding all original BPUs of the original picture, the encoder can proceed to encode the next picture in video sequence 202.

Referring to process 200A, the encoder can receive video sequence 202 generated by a video capturing device (e.g., a camera). The term “receive” used herein can refer to receiving, inputting, acquiring, retrieving, obtaining, reading, accessing, or any action in any manner for inputting data.

At prediction stage 204, at a current iteration, the encoder can receive an original BPU and prediction reference 224, and perform a prediction operation to generate prediction data 206 and predicted BPU 208. Prediction reference 224 can be generated from the reconstruction path of the previous iteration of process 200A. The purpose of prediction stage 204 is to reduce information redundancy by extracting prediction data 206 that can be used to reconstruct the original BPU as predicted BPU 208 from prediction data 206 and prediction reference 224.

Ideally, predicted BPU 208 can be identical to the original BPU. However, due to non-ideal prediction and reconstruction operations, predicted BPU 208 is generally slightly different from the original BPU. For recording such differences, after generating predicted BPU 208, the encoder can subtract it from the original BPU to generate residual BPU 210. For example, the encoder can subtract values (e.g., grayscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct original BPU without significant quality deterioration. Thus, the original BPU is compressed.

To further compress residual BPU 210, at transform stage 212, the encoder can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, the encoder can restore residual BPU 210 by an inverse operation of the transform (referred to as an “inverse transform”). For example, to restore a pixel of residual BPU 210, the inverse transform can be multiplying values of corresponding pixels of the base patterns by respective associated coefficients and adding the products to produce a weighted sum. For a video coding standard, both the encoder and decoder can use the same transform algorithm (thus the same base patterns). Thus, the encoder can record only the transform coefficients, from which the decoder can reconstruct residual BPU 210 without receiving the base patterns from the encoder. Compared with residual BPU 210, the transform coefficients can have fewer bits, but they can be used to reconstruct residual BPU 210 without significant quality deterioration. Thus, residual BPU 210 is further compressed.

The encoder can further compress the transform coefficients at quantization stage 214. In the transform process, different base patterns can represent different variation frequencies (e.g., brightness variation frequencies). Because human eyes are generally better at recognizing low-frequency variation, the encoder can disregard information of high-frequency variation without causing significant quality deterioration in decoding. For example, at quantization stage 214, the encoder can generate quantized transform coefficients 216 by dividing each transform coefficient by an integer value (referred to as a “quantization scale factor”) and rounding the quotient to its nearest integer. After such an operation, some transform coefficients of the high-frequency base patterns can be converted to zero, and the transform coefficients of the low-frequency base patterns can be converted to smaller integers. The encoder can disregard the zero-value quantized transform coefficients 216, by which the transform coefficients are further compressed. The quantization process is also invertible, in which quantized transform coefficients 216 can be reconstructed to the transform coefficients in an inverse operation of the quantization (referred to as “inverse quantization”).

Because the encoder disregards the remainders of such divisions in the rounding operation, quantization stage 214 can be lossy. Typically, quantization stage 214 can contribute the most information loss in process 200A. The larger the information loss is, the fewer bits the quantized transform coefficients 216 can need. For obtaining different levels of information loss, the encoder can use different values of the quantization parameter or any other parameter of the quantization process.

At binary coding stage 226, the encoder can encode prediction data 206 and quantized transform coefficients 216 using a binary coding technique, such as, for example, entropy coding, variable length coding, arithmetic coding, Huffman coding, context-adaptive binary arithmetic coding, or any other lossless or lossy compression algorithm. In some embodiments, besides prediction data 206 and quantized transform coefficients 216, the encoder can encode other information at binary coding stage 226, such as, for example, a prediction mode used at prediction stage 204, parameters of the prediction operation, a transform type at transform stage 212, parameters of the quantization process (e.g., quantization parameters), an encoder control parameter (e.g., a nitrate control parameter), or the like. The encoder can use the output data of binary coding stage 226 to generate video bitstream 228. In some embodiments, video bitstream 228 can be further packetized for network transmission.

Referring to the reconstruction path of process 200A, at inverse quantization stage 218, the encoder can perform inverse quantization on quantized transform coefficients 216 to generate reconstructed transform coefficients. At inverse transform stage 220, the encoder can generate reconstructed residual BPU 222 based on the reconstructed transform coefficients. The encoder can add reconstructed residual BPU 222 to predicted BPU 208 to generate prediction reference 224 that is to be used in the next iteration of process 200A.

It should be noted that other variations of the process 200A can be used to encode video sequence 202. In some embodiments, stages of process 200A can be performed by the encoder in different orders. In some embodiments, one or more stages of process 200A can be combined into a single stage. In some embodiments, a single stage of process 200A can be divided into multiple stages. For example, transform stage 212 and quantization stage 214 can be combined into a single stage. In some embodiments, process 200A can include additional stages. In some embodiments, process 200A can omit one or more stages in FIG. 2A.

FIG. 2B illustrates a schematic diagram of another example encoding process 200B, consistent with embodiments of the disclosure. Process 200B can be modified from process 200A. For example, process 200B can be used by an encoder conforming to a hybrid video coding standard (e.g., H26x series). Compared with process 200A, the forward path of process 200B additionally includes mode decision stage 230 and divides prediction stage 204 into spatial prediction stage 2042 and temporal prediction stage 2044. The reconstruction path of process 200B additionally includes loop filter stage 232 and buffer 234.

Generally, prediction techniques can be categorized into two types: spatial prediction and temporal prediction. Spatial prediction (e.g., an intra-picture prediction or “intra prediction”) can use pixels from one or more already coded neighboring BPUs in the same picture to predict the target BPU. That is, prediction reference 224 in the spatial prediction can include the neighboring BPUs. The spatial prediction can reduce the inherent spatial redundancy of the picture. Temporal prediction (e.g., an inter-picture prediction or “inter prediction”) can use regions from one or more already coded pictures to predict the target BPU. That is, prediction reference 224 in the temporal prediction can include the coded pictures. The temporal prediction can reduce the inherent temporal redundancy of the pictures.

Referring to process 200B, in the forward path, the encoder performs the prediction operation at spatial prediction stage 2042 and temporal prediction stage 2044. For example, at spatial prediction stage 2042, the encoder can perform the intra prediction. For an original BPU of a picture being encoded, prediction reference 224 can include one or more neighboring BPUs that have been encoded (in the forward path) and reconstructed (in the reconstructed path) in the same picture. The encoder can generate predicted BPU 208 by extrapolating the neighboring BPUs. The extrapolation technique can include, for example, a linear extrapolation or interpolation, a polynomial extrapolation or interpolation, or the like. In some embodiments, the encoder can perform the extrapolation at the pixel level, such as by extrapolating values of corresponding pixels for each pixel of predicted BPU 208. The neighboring BPDs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, parameters of the extrapolation, a direction of the used neighboring BPUs with respect to the original BPU, or the like.

For another example, at temporal prediction stage 2044, the encoder can perform the inter prediction. For an original BPU of a target picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, the encoder can add reconstructed residual BPU 222 to predicted BPU 208 to generate a reconstructed BPU. When all reconstructed BPUs of the same picture are generated, the encoder can generate a reconstructed picture as a reference picture. The encoder can perform an operation of “motion estimation” to search for a matching region in a scope (referred to as a “search window”) of the reference picture. The location of the search window in the reference picture can be determined based on the location of the original BPU in the target picture. For example, the search window can be centered at a location having the same coordinates in the reference picture as the original BPU in the target picture and can be extended out for a predetermined distance. When the encoder identifies (e.g., by using a pel-recursive algorithm, a block-matching, algorithm, or the like) a region similar to the original BPU in the search window, the encoder can determine such a region as the matching region. The matching region can have different dimensions (e.g., being smaller than, equal to, larger than, or in a different shape) from the original BPU. Because the reference picture and the target picture are temporally separated in the timeline (e.g., as shown in FIG. 1), it can be deemed that the matching region “moves” to the location of the original BPU as time goes by. The encoder can record the direction and distance of such a motion as a “motion vector,” When multiple reference pictures are used (e.g., as picture 106 in FIG. 1), the encoder can search for a matching region and determine its associated motion vector for each reference picture. In some embodiments, the encoder can assign weights to pixel values of the matching regions of respective matching reference pictures.

The motion estimation can be used to identify various types of motions, such as, for example, translations, rotations, zooming, or the like. For inter prediction, prediction data 206 can include, for example, locations (e.g., coordinates) of the matching region, the motion vectors associated with the matching region, the number of reference pictures, weights associated with the reference pictures, or the like.

For generating predicted BPU 208, the encoder can perform an operation of “motion compensation.” The motion compensation can be used to reconstruct predicted BPU 208 based on prediction data 206 (e.g., the motion vector) and prediction reference 224. For example, the encoder can move the matching region of the reference picture according to the motion vector, in which the encoder can predict the original BPU of the target picture. When multiple reference pictures are used (e.g., as picture 106 in FIG. 1), the encoder can move the matching regions of the reference pictures according to the respective motion vectors and average pixel values of the matching regions. In some embodiments, if the encoder has assigned weights to pixel values of the matching regions of respective matching reference pictures, the encoder can add a weighted sum of the pixel values of the moved matching regions.

In some embodiments, the inter prediction can be unidirectional or bidirectional. Unidirectional inter predictions can use one or more reference pictures in the same temporal direction with respect to the target picture. For example, picture 104 in FIG. 1 is a unidirectional inter-predicted picture, in which the reference picture (i.e., picture 102) precedes picture 104. Bidirectional inter predictions can use one or more reference pictures at both temporal directions with respect to the target picture. For example, picture 106 in FIG. 1 is a bidirectional inter-predicted picture, in which the reference pictures (i.e., pictures 104 and 108) are at both temporal directions with respect to picture 104.

Still referring to the forward path of process 200B, after spatial prediction stage 2042 and temporal prediction stage 2044, at mode decision stage 230, the encoder can select a prediction mode (e.g., one of the intra prediction or the inter prediction) for the current iteration of process 200B. For example, the encoder can perform a rate-distortion optimization technique, in which the encoder can select a prediction mode to minimize a value of a cost function depending on a bit rate of a candidate prediction mode and distortion of the reconstructed reference picture under the candidate prediction mode. Depending on the selected prediction mode, the encoder can generate the corresponding predicted BPU 208 and predicted data 206.

In the reconstruction path of process 200B, if intra prediction mode has been selected in the forward path, after generating prediction reference 224 (e.g., the target BPU that has been encoded and reconstructed in the target picture), the encoder can directly feed prediction reference 224 to spatial prediction stage 2042 for later usage (e.g., for extrapolation of a next BPU of the target picture). The encoder can feed prediction reference 224 to loop filter stage 232, at which the encoder can apply a loop filter to prediction reference 224 to reduce or eliminate distortion (e.g., blocking artifacts) introduced during coding of the prediction reference 224. The encoder can apply various loop filter techniques at loop filter stage 232, such as, for example, deblocking, sample adaptive offsets, adaptive loop filters, or the like. The loop-filtered reference picture can be stored in buffer 234 (or “decoded picture buffer”) for later use (e.g., to be used as an inter-prediction reference picture for a future picture of video sequence 202). The encoder can store one or more reference pictures in buffer 234 to be used at temporal prediction stage 2044. In some embodiments, the encoder can encode parameters of the loop filter (e.g., a loop filter strength) at binary coding stage 226, along with quantized transform coefficients 216, prediction data 206, and other information.

FIG. 3A illustrates a schematic diagram of an example decoding process 300A, consistent with embodiments of the disclosure. Process 300A can be a decompression process corresponding to the compression process 200A in FIG. 2A. In some embodiments, process 300A can be similar to the reconstruction path of process 200A. A decoder can decode video bitstream 228 into video stream 304 according to process 300A. Video stream 304 can be very similar to video sequence 202. However, due to the information loss in the compression and decompression process e.g., quantization stage 214 in FIGS. 2A-2B), generally, video stream 304 is not identical to video sequence 202. Similar to processes 200A and 200B in FIGS. 2A-2B, the decoder can perform process 300A at the level of basic processing units (BPUs) for each picture encoded in video bitstream 228. For example, the decoder can perform process 300A in an iterative manner, in which the decoder can decode a basic processing unit in one iteration of process 300A. In some embodiments, the decoder can perform process 300A in parallel for regions (e.g., regions 114-118) of each picture encoded in video bitstream 228.

In FIG. 3A, the decoder can teed a portion of video bitstream 228 associated with a basic processing unit (referred to as an “encoded BPU”) of an encoded picture to binary decoding stage 302. At binary decoding stage 302, the decoder can decode the portion into prediction data 206 and quantized transform coefficients 216. The decoder can feed quantized transform coefficients 216 to inverse quantization stage 218 and inverse transform stage 220 to generate reconstructed residual BPU 222. The decoder can feed prediction data 206 to prediction stage 204 to generate predicted BPU 208. The decoder can add reconstructed residual BPU 222 to predicted BPU 208 to generate predicted reference 224. In some embodiments, predicted reference 224 can be stored in a buffer (e.g., a decoded picture buffer in a computer memory). The decoder can feed predicted reference 224 to prediction stage 204 for performing a prediction operation in the next iteration of process 300A.

The decoder can perform process 300A iteratively to decode each encoded BPU of the encoded picture and generate predicted reference 224 for encoding the next encoded BPU of the encoded picture. After decoding all encoded BPUs of the encoded picture, the decoder can output the picture to video stream 304 for display and proceed to decode the next encoded picture in video bitstream 228.

At binary decoding stage 302, the decoder can perform an inverse operation of the binary coding technique used by the encoder (e.g., entropy coding, variable length coding, arithmetic coding, Huffman coding, context-adaptive binary arithmetic coding, or any other lossless compression algorithm). In some embodiments, besides prediction data 206 and quantized transform coefficients 216, the decoder can decode other information at binary decoding stage 302, such as, for example, a prediction mode, parameters of the prediction operation, a transform type, parameters of the quantization process (e.g., quantization parameters), an encoder control parameter (e.g., a bitrate control parameter), or the like. In some embodiments, if video bitstream 228 is transmitted over a network in packets, the decoder can depacketize video bitstream 228 before feeding it to binary decoding stage 302.

FIG. 3B illustrates a schematic diagram of another example decoding process 300B, consistent with embodiments of the disclosure. Process 300B can be modified from process 300A. For example, process 300B can be used by a decoder conforming to a hybrid video coding standard (e.g., H.26x series). Compared with process 300A, process 300B additionally divides prediction stage 204 into spatial prediction stage 2042 and temporal prediction stage 2044, and additionally includes loop filter stage 232 and buffer 234.

In process 300B, for an encoded basic processing unit (referred to as a “current BPU” or “target BPU”) of an encoded picture (referred to as a “current picture” or “target picture”) that is being decoded, prediction data 206 decoded from binary decoding stage 302 by the decoder can include various types of data, depending on what prediction mode was used to encode the target BPU by the encoder. For example, if intra prediction was used by the encoder to encode the target BPU, prediction data 206 can include a prediction mode indicator (e.g., a flag value) indicative of the intra prediction, parameters of the intra prediction operation, or the like. The parameters of the intra prediction operation can include, for example, locations (e.g., coordinates) of one or more neighboring BPUs used as a reference, sizes of the neighboring BPUs, parameters of extrapolation, a direction of the neighboring BPUs with respect to the original BPU, or the like, For another example, if inter prediction was used by the encoder to encode the target BPU, prediction data 206 can include a prediction mode indicator (e.g., a flag value) indicative of the inter prediction, parameters of the inter prediction operation, or the like. The parameters of the inter prediction operation can include, for example, the number of reference pictures associated with the target BPU, weights respectively associated with the reference pictures, locations (e.g., coordinates) of one or more matching regions in the respective reference pictures, one or more motion vectors respectively associated with the matching regions, or the like.

Based on the prediction mode indicator, the decoder can decide whether to perform a spatial prediction (e.g., the intra prediction) at spatial prediction stage 2042 or a temporal prediction (e.g., the inter prediction) at temporal prediction stage 2044. The details of performing such spatial prediction or temporal prediction are described in FIG. 2B and will not be repeated hereinafter. After performing such spatial prediction or temporal prediction, the decoder can generate predicted BPU 208. The decoder can add predicted BPU 208 and reconstructed residual BPU 222 to generate prediction reference 224, as described in FIG. 3A.

In process 300B, the decoder can feed predicted reference 224 to spatial prediction stage 2042 or temporal prediction stage 2044 for performing a prediction operation in the next iteration of process 300B. For example, if the target BPU is decoded using the intra prediction at spatial prediction stage 2042, after generating prediction reference 224 (e.g., the decoded target BPU), the decoder can directly feed prediction reference 224 to spatial prediction stage 2042 for later usage (e.g., for extrapolation of a next BPU of the target picture). If the target BPU is decoded using the inter prediction at temporal prediction stage 2044, after generating prediction reference 224 (e.g., a reference picture in which all BPUs have been decoded), the decoder can feed prediction reference 224 to loop filter stage 232 to reduce or eliminate distortion blocking artifacts). The decoder can apply a loop filter to prediction reference 224, in a way as described in FIG. 2B. The loop-filtered reference picture can be stored in buffer 234 (e.g., a decoded picture buffer in a computer memory) for later use (e.g., to be used as an inter-prediction reference picture for a future encoded picture of video bitstream 228). The decoder can store one or more reference pictures in buffer 234 to be used at temporal prediction stage 2044. In some embodiments, prediction data can further include parameters of the loop filter (e.g., a loop filter strength). In some embodiments, when the prediction mode indicator of prediction data 206 indicates that inter prediction was used to encode the target BPU.

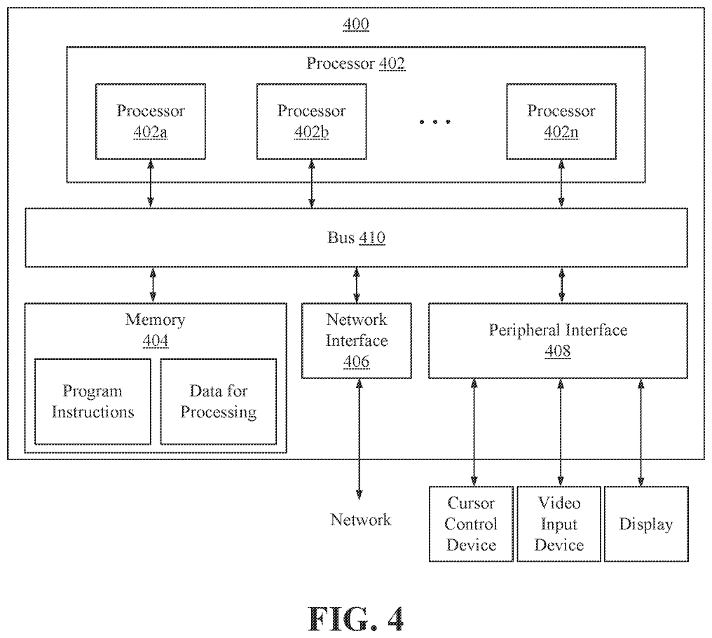

FIG. 4 is a block diagram of an example apparatus 400 for encoding or decoding a video, consistent with embodiments of the disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in processes 200A, 200B, 300A, or 300B) and data for processing (e.g., video sequence 202, video bitstream 228, or video stream 304). Processor 402 can access the program instructions and data for processing (e.g., via bus 410), and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processor 402 and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, a near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device a camera or an input interface communicatively coupled to a video archive), or the like.

It should be noted that video codecs (e.g., a codec performing process 200A, 200B, 300A, or 300B) can be implemented as any combination of any software or hardware modules in apparatus 400. For example, some or all stages of process 200A, 200B, 300A, or 300B can be implemented as one or more software modules of apparatus 400, such as program instructions that can be loaded into memory 404. For another example, some or all stages of process 200A, 200B, 300A, or 300B can be implemented as one or more hardware modules of apparatus 400, such as a specialized data processing circuit (e.g., an FPGA, an ASIC, an NPU, or the like).

In the quantization and inverse quantization functional blocks (e.g., quantization 214 and inverse quantization 218 of FIG. 2A or FIG. 2B, inverse quantization 218 of FIG. 3A or FIG. 3B), a quantization parameter (QP) is used to determine the amount of quantization (and inverse quantization) applied to the prediction residuals. Initial QP values used for coding of a picture or slice can be signaled at the high level, for example, using init_qp_minus26 syntax element in the Picture Parameter Set (PPS) and using slice_qp_delta syntax element in the slice header. Further, the QP values can be adapted at the local level for each CU using delta QP values sent at the granularity of quantization groups.

In the Versatile Video Coding (e.g., VVC/H.266) standard, a picture can be partitioned into a set of CTUs, and multiple CTUs can form a tile, a slice, or a subpicture. When a picture includes three sample arrays for storing three color components (e.g., a luma component and two chroma components), a CTU can include N×N (N being an integer) blocks of luma samples, each block of luma sample being associated with two blocks of chroma samples.

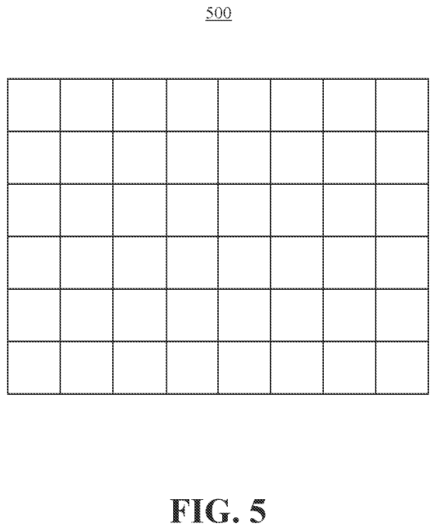

By way of example, FIG. 5 is a schematic diagram illustrating structures of a picture 500 partitioned into blocks, consistent with some embodiments of the disclosure. In FIG. 5, each square represents a CTU, and picture 500 is partitioned into 8×6 CTUs. In some embodiments, the maximum allowed size of a luma block in a CTU is 128×128, while the maximum allowed size of a luma transform block is 64×64. In some embodiments, the minimum allowed size of a luma block in a CTU is 32×32. It should be noted that the maximum allowed size of the luma block, the maximum allowed size of the luma transform block, and the minimum allowed size of the luma block can be specified to be different, values and different shapes in various video coding standards, and this disclosure does not limit them to the above-described examples.

Consistent with some embodiments of the disclosure, a picture can be partitioned into one or more tile rows and one or more tile columns. A “tile” in this disclosure can refer to a sequence of CTUs that covers a rectangular region of a picture. A “slice” in this disclosure can include an integer number of complete tiles, or include an integer number of consecutive. complete CTU rows that are within a tile of a picture.

In some embodiments, a picture can be partitioned into slices in two modes, a “raster-scan slice mode” and a “rectangular slice mode.” In the raster-scan slice mode, a slice of a picture can include a sequence of complete tiles in a raster-scan order of the picture. In the rectangular slice mode, a slice of a picture can include a number of complete tiles that collectively form a rectangular region of the picture, or include a number of consecutive, complete CTU rows of a tile that collectively form a rectangular region of the picture. Tiles within a rectangular slice can be scanned in the raster-scan order within the formed rectangular region corresponding to the rectangular slice.

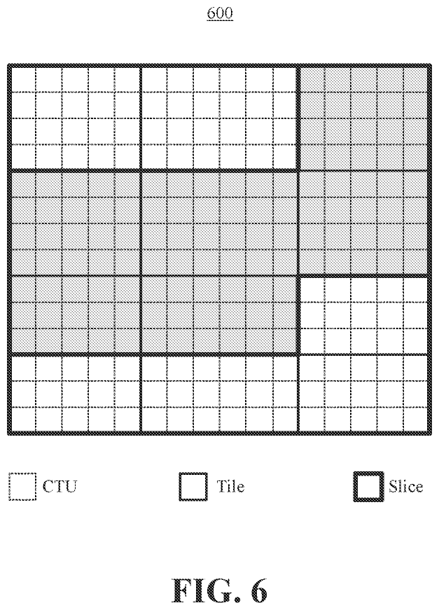

By way of example, FIG. 6 is a schematic diagram illustrating structures of a picture 600 partitioned in a raster-scan slice mode, consistent with some embodiments of the disclosure. In FIG, 6, each dotted-line square represents a CTU, and picture 600 is partitioned into 16×14 CTUs. The CTUs of picture 600 form twelve tiles, including four tile rows and three tile columns, the boundaries of which are represented by thinner solid lines overlapping the dotted lines. The tiles of picture 600 form three slices represented in different shades, the boundaries of which are represented by thicker solid lines overlapping the dotted lines or the thinner solid lines. As illustrated in FIG. 6, the three slices of picture 600 are partitioned in a raster-scan order, and each of the three slices includes an integer number of complete tiles.

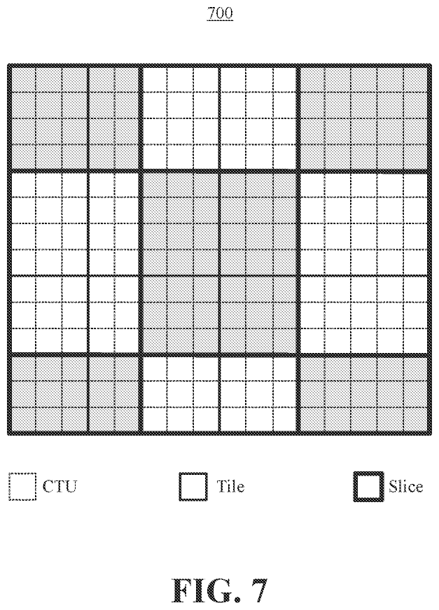

By way of example, FIG. 7 is a schematic diagram illustrating structures of a picture 700 partitioned in a rectangular slice mode, consistent with some embodiments of the disclosure. In FIG. 7, each dotted-line square represents a CTU, and picture 700 is partitioned into 16×14 CTUs. The CTUs of picture 700 form twenty tiles, including four tile rows and five tile columns, the boundaries of which are represented by thinner solid lines overlapping the dotted lines. The tiles of picture 700 form nine slices represented in different shades, the boundaries of which are represented by thicker solid lines overlapping the dotted lines or the thinner solid lines. As illustrated in FIG. 7, the nine slices of picture 700 are partitioned in a rectangular manner that forms nine rectangular regions, and each of the nine slices includes an integer number of complete tiles.

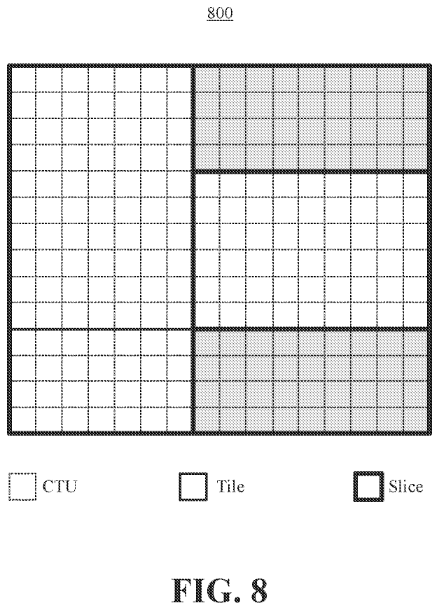

By way of example, FIG. 8 is a schematic diagram illustrating structures of a picture 800 partitioned in a rectangular slice mode, consistent with some embodiments of the disclosure. In FIG. 8, each dotted-line square represents a CTU, and picture 800 is partitioned into 16×14 CTUs. The CTUs of picture 800 form four tiles, including two tile rows and two tile columns, the boundaries of which are represented by thinner solid lines overlapping the dotted lines. For example, a first tile can be on the top left with a size of 7×10 CTUs. A second tile can be on the bottom left with a size of 7×4 CTUs. A third tile can be on the top right with a size of 9×10 CTUs. A fourth tile can be on the bottom right with a size of 9×4 CTUs. The tiles of picture 800 form four slices represented in different shades, the boundaries of which are represented by thicker solid lines overlapping the dotted lines or the thinner solid lines. As illustrated in FIG. 8, the four slices of picture 800 are partitioned in a rectangular manner that forms four rectangular regions, and each of the four slices includes either an integer number of complete tiles or an integer number of consecutive, complete CTU rows that are within a tile of picture 800. For example, a first slice (represented in white color) can include two complete tiles (i.e., the above-described first and second tiles), with a size of 7×14 CTUs. A second slice (represented in gray color) can include a part of the above-described third tile, with a size of 9×4 CTUs. A third slice (represented in white color) can include another part of the above-described third tile, with a size of 9×6 CTUs. A fourth slice (represented in gray color) can include a complete tile (e.g., the above-described fourth tile), with a size of 9×4 CTUs.

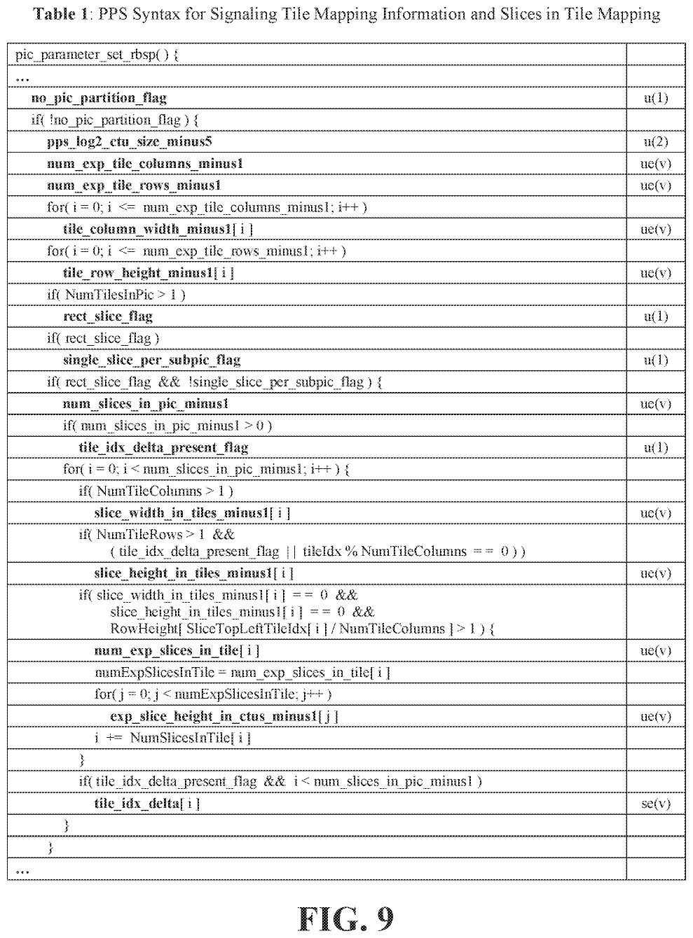

In VVC draft 8, tile mapping information is signaled in a picture parameter set (PPS). FIG. 9 illustrates Table 1 of example PPS syntax for signaling tile mapping and slices in tile mapping, consistent with some embodiments of the disclosure. The PPS syntax in Table 1 can conform to VVC draft 8. In Table 1, the flag “no_pic_partition_flag” can specify that no picture partitioning is applied to any picture that refers to the PPS (that includes the flag “no_pic_partition_flag”) when it is equal to 1, and can specify that each picture that refers to the PPS may be partitioned into more than one tile or slice when it is equal to 0. In VVC draft 8, it is a bitstream conformance requirement that the value of “no_pic_partition_flag” is the same for all PPS's that are referred to by coded pictures within a coded layer video sequence (CLVS). It is also a bitstream conformance requirement that the value of “no_pic_partition flag” is not equal to 1 when the value of the operation of “sps_nun_subpics_minus1+1” yields a value greater than 1.

In Table 1, the flag “pps_log2_ctu_size_minus5 plus 5” specifies a lima coding tree block size for each CTU. In VVC draft 8, “pps_log2_ctu_size_minus5” is equal to “sps_log2_ctu_size_minus5.”

In Table 1, “num_exp_tile_columns_minus1” plus 1 specifies the number of tile column widths that are explicitly provided. In VVC draft 8, the value of “num_exp_tile_columns_minus1” is in an inclusive range of 0 to “PicWidthInCtbsY−1.” When the flag “no_pic_partition_flag” is equal to 1, the value of “num_exp_tile_columns_minus1” is inferred to be 0.

In Table 1, “num_exp_tile_rows_minus1” plus 1 specifies the number of tile row heights that are explicitly provided. In VVC draft 8, the value of “num_exp_tile_rows_minus1” is in an inclusive range of 0 to “PicHeightInCtbsY−1.” When the flag “no_pic_partition_flag” is equal to 1, the value of “num-tile_rows_minus1” is inferred to be 0.

In Table 1, “tile_column_width_minus1[i]” plus 1 specifies a width of the i-th tile column in units of CTB, in which i is in an inclusive range of 0 to “num_exp_tile_columns_minus1−1.” In VVC draft 8, the flag “tile_column_width_minus1[num_exp_tile_columns_minus1]” is used to derive a width of the tile columns with index greater than or equal to “num_exp_tile_columns_minus1” as specified herein. The value of “tile_column_width_minus1[i]” is in an inclusive range of 0 to “PicWidthInCtbsY−1.” When not present in the PPS, the value of “tile_column_width_minus1[0]” is inferred to be equal to “PicWidthInCtbsY−1.”

In Table 1, “tile_row_height_minus1[i]” plus 1 specifies the height of the i-th tile row in units of CTBs, in which i is in an inclusive range of 0 to “num_exp_tile_rows_minus1−1.” In VVC, draft 8, the flag “tile_row_height_minus1[num_exp_tile_rows_minus1]” is used to derive a height of the tile rows with index greater than or equal to “num_exp_tile_rows_minus1” as specified herein. The value of “tile_row_height_minus1[i]” is in an inclusive range of 0 to “PicHeightInCtbsY−1.” When not present in the PPS, the value of “tile_row_height_minus1[0]” is inferred to be equal to “PicHeightInCtbsY−1.”

In Table 1, when being equal to 0, the flag “rect_slice_flag” specifies that tiles within each slice are in a raster-scan order, and that the slice information is not signalled in PPS. When being equal to 1, the flag “rect_slice_flag” specifies that tiles within each slice cover a rectangular region of the picture, and that the slice information is signalled in the PPS. When not present in the PPS, the flag “rect_slice_flag” is inferred to be equal to 1. In VVC draft 8, when the flag “subpic_info_present_flag” is equal to 1, the value of “rect_slice_flag” is equal to 1.

In Table 1, when being equal to 0, the flag “single_slice_per_subpic_flag” specifies that each subpicture can consist of one or more rectangular slices. When being equal to 1, the flag “single_slice_per_subpic_flag” specifies that each subpicture consists of one and only one rectangular slice, and the value of “num_slices_in_pic_minus1” is inferred to be equal to the value of “sps_num_subpics_minus1.” When not present, the flag “single_slice_per_subpic_flag” is inferred to be equal to 0.

In Table 1, “num_slices_in_pic_minus1” plus 1 specifies the number of rectangular slices in each picture that refers to the PPS. In VVC draft 8, the value of “num_slices_in_pic_minus1” is in an inclusive range of 0 to “MaxSlicesPerPicture−1,” where “MaxSlicesPerPicture” is a level limit for a maximum allowed number of slices in a picture. When the flag “no_pic_partition_flag” is equal to 1, the value of “num_slices_in_pic_minus1” is inferred to be equal to 0.

In Table 1, when being equal to 0, the flag “tile_idx_delta_present_flag” specifies that “tile_idx_delta” values are not present in the PPS, and that all rectangular slices in pictures referring to the PPS are specified in a raster-scan order. When being equal to 1, the flag “tile_idx_delta_present_flag” specifies that “tile_idx_delta” values can be present in the PPS, and that all rectangular slices in pictures referring to the PPS are specified in the order indicated by the values of “tile_idx_delta.” When not present, the value of “tile_idx_delta_present_flag” is inferred to be equal to 0.

In Table 1, “slice_width_in_tiles_minus1[i]” plus 1 specifies a width of the i-th rectangular slice in units of tile columns. In VVC draft 8, the value of “slice_width_in_tiles_minus1[i]” is in an inclusive range of 0 to “NumTileColumns−1.” When “slice_width_in_tiles_minus1[i]” is not present in the PPS, the following rules apply: If “NumTileColumns” is equal to 1, the value of “slice_width_in_tiles_minus1[i]” is inferred to be equal to 0; otherwise, the value of “slice_width_in_tiles_minus1[i]” is inferred as specified above.

In Table 1, “slice_height_in_tiles_minus1[i]” plus 1 specifies a height of the i-th rectangular slice in units of tile rows. in VVC draft 8, the value of “slice_height_in_tiles_minus1[i]” is in an inclusive range of 0 to “NumTileRows−1.” When “slice_height_in_tiles_minus1[i]” is not present in the PPS, the following rules apply: If “NumTileRows” is equal to 1, or if “tile_idx_delta_present_flag” is equal to 0 and the value of “tileIdx % NumTileColumns” is greater than 0, the value of “slice_height_in_tiles_minus1[i]” is inferred to be equal to 0; otherwise, if “NumTileRows” is not equal to 1, and if either “tile_idx_delta_present_flag” is equal to 1 or the value of “tileIdx % NumTileColumns” is equal to 0, the value of “slice_height_in_tiles_minus1[i]” is inferred to be equal to the value of “slice_height_in_tiles_minus1[i].”

In Table 1, the value of “num_exp_slices_in_tile[i]” specifies a number of slice heights explicitly provided in the current tile that includes more than one rectangular slices. In VVC draft 8, the value of “num_exp_slices_in_tile[i]” is in an inclusive range of 0 to “RowHeight[tileY]−1,” where “tileY” represents a tile row index containing the i-th slice. When not present, the value of “num_exp_slices_in_tile[i]” is inferred to be equal to 0. When “num_exp_slices_in_tile[i]” is equal to 0, the value of the variable “NumSlicesInTile[i]” is derived to be equal to 1.

In Table 1, “exp_slice_height_in_ctus_minus1[j]” plus 1 specifies a height of the j-th rectangular slice in the current tile in units of CTU rows. In VVC draft 8, the value of “exp_slice_height_in_ctus_minus1[j]” is in an inclusive range of 0 to “RowHeight[tileY]−1,” where “tileY” represents a tile row index of the current tile.

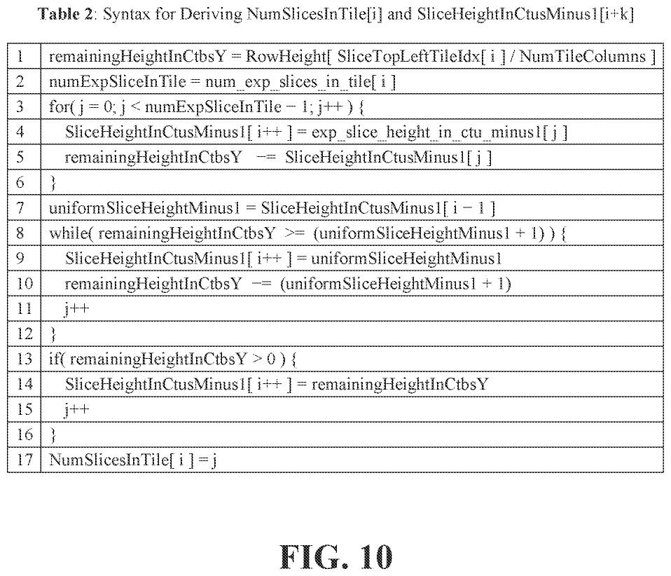

In VVC draft 8, when “num_exp_slices_in_tile[i]” is greater than 0, the variables “NumSlicesInTile[i]” and “SliceHeightInCtusMinus1[i+k]” (k being in an inclusive range of 0 to “NumSlicesInTile[i]−1”) can be derived in a manner illustrated in FIG. 10. FIG. 10 illustrates Table 2 of example syntax for deriving “NumSlicesInTile[i]” and “SliceHeightInCtusMinus1[i+k]” when “num_exp_slices_in_tile[i]” is greater than 0, consistent with some embodiments of the disclosure. Table 2 includes 17 lines, as indicated by its leftmost column.

Referring back to Table 1 in FIG. 9, the variable “tile_idx_delta[i]” specifies the difference between a tile index of the first tile in the i-th rectangular slice and a tile index of the first tile in the (i+1)-th rectangular slice. In VVC draft 8, the value of “tile_idx_delta[i]” is in an inclusive range of “-NumTilesInPic+1” to “NumTilesInPic−1.” When not present, the Value of “tile_idx_delta[i]” is inferred to be equal to 0. When present, the value of “tile_idx_delta[i]” is not equal to 0. The variable “NumTilesInPic” is set to be equal to “NumTileColumns×NumTileRows.”

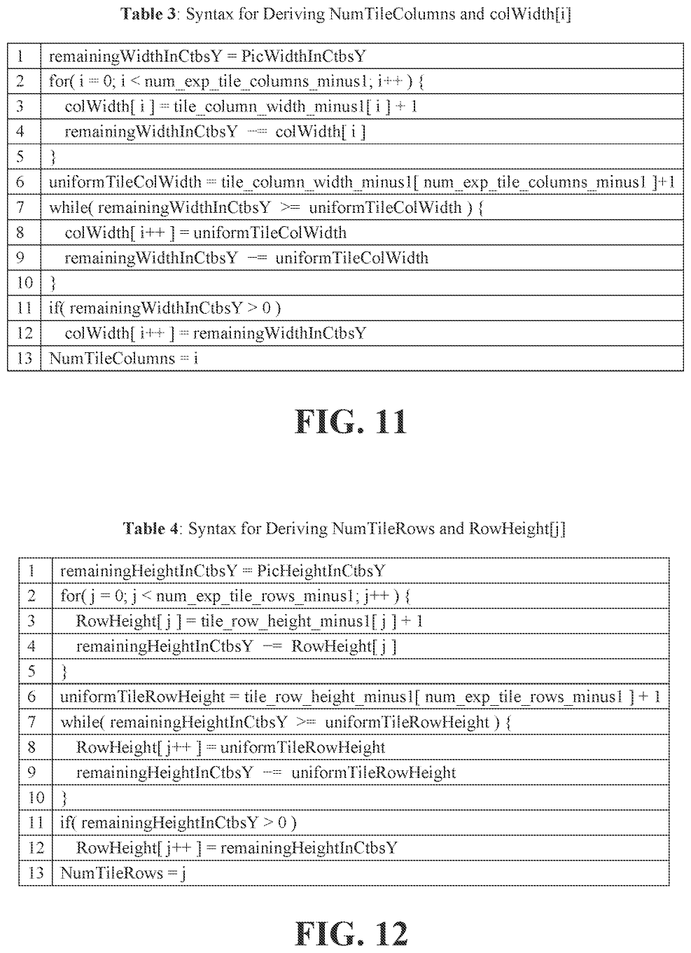

The variable “NumTileColumns” that specifies the number of tile columns in Table 1 and the list “colWidth[i]'” being in an inclusive range from 0 to “NumTileColumn−1”) that specifies the width of the i-th tile column in units of CTBs in Table 1 can be derived in a manner illustrated in FIG. 11. FIG. 11 illustrates Table 3 of example syntax for deriving “NumTileColumns” and “colWidth[i]” in Table 1, consistent with some embodiments of the disclosure. Table 3 includes 13 lines, as indicated by its leftmost column.

The variable “NumTileRows” that specifies the number of tile rows in Table 1 and the list “RowHeight[j]” (j being in an inclusive range from 0 to “NumTileRows−1”) that specifies the height of the j-th tile row in units of CTBs in Table 1 can be derived in a manner illustrated in FIG. 12. FIG. 12 illustrates Table 4 of example syntax for deriving “NumTileRows” and “RowHeight[j]” in Table 1, consistent with some embodiments of the disclosure. Table 4 includes 13 lines, as indicated by its leftmost column.

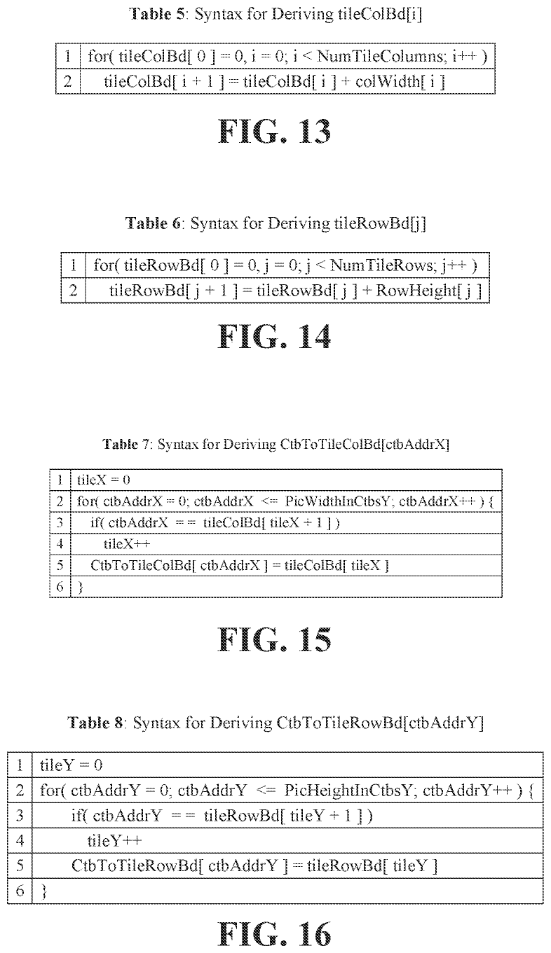

In VVC draft 8, the list “tileColBd[i]” (i being in an inclusive range from 0 to “NumTileColumns”) that specifies the location of the i-th tile column boundary in units of CTBs can be derived in a manner illustrated in FIG. 13. FIG. 13 illustrates Table 5 of example syntax for deriving “tileColBd[i],” consistent with some embodiments of the disclosure. Table 5 includes 2 lines, as indicated by its leftmost column. It should be noted that the size of the array “tileColBd[ ]” in Table 5 is one greater than the actual number of tile columns in the derivation of the array “CtbToTileColBd[ ].”

In VVC draft 8, the list “tiieRowBd[j]” (j being in an inclusive range from 0 to “NumTileRows”) that specifies the location of the j-th tile row boundary in units of CTBs can be derived in a manner illustrated in FIG. 14. FIG. 14 illustrates Table 6 of example syntax for deriving “tileRowBd[j],” consistent with some embodiments of the disclosure. Table 6 includes 2 lines, as indicated by its leftmost column. It should be noted that the size of the array “tileRowBd[ ]” in Table 6 is one greater than the actual number of tile rows in the derivation of the array “CtbToTileRowBd[ ].”

In VVC draft 8, the list “CtbToTileColBd[ctbAddrX]” (“ctbAddrX” being a horizontal address of a CTB which is in an inclusive range from 0 to “PicWidthInCtbsY”) that specifies the conversion from a horizontal CTB address to a left tile column boundary in units of CTBs can be derived in a manner illustrated in FIG. 15. FIG. 15 illustrates Table 7 of example syntax for deriving “CtbToTileColBd[ctbAddrX],” consistent with some embodiments of the disclosure. Table 7 includes 6 lines, as indicated by its leftmost column. It should be noted that the size of the array “CtbToTileColBd[ ]” in Table 7 is one greater than the actual number of picture width in CTBs.

In VVC draft 8, the list “CtbToTileRowBd[ctbAddrY]” (“ctbAddrY” being a vertical address of a CTB which is in an inclusive range from 0 to “PicHeightInCtbsY”) that specifies the conversion from a vertical CTB address to a top tile column boundary in units of CTBs can be derived in a manner illustrated in FIG. 16. FIG. 16 illustrates Table 8 of example syntax for deriving “CtbToTileRowBd[ctbAddrY],” consistent with some embodiments of the disclosure. Table 8 includes 6 lines, as indicated by its leftmost column. It should be noted that the size of the array “CtbToTileRowBd[ ]” in Table 8 is one greater than the actual number of picture height in CTBs.

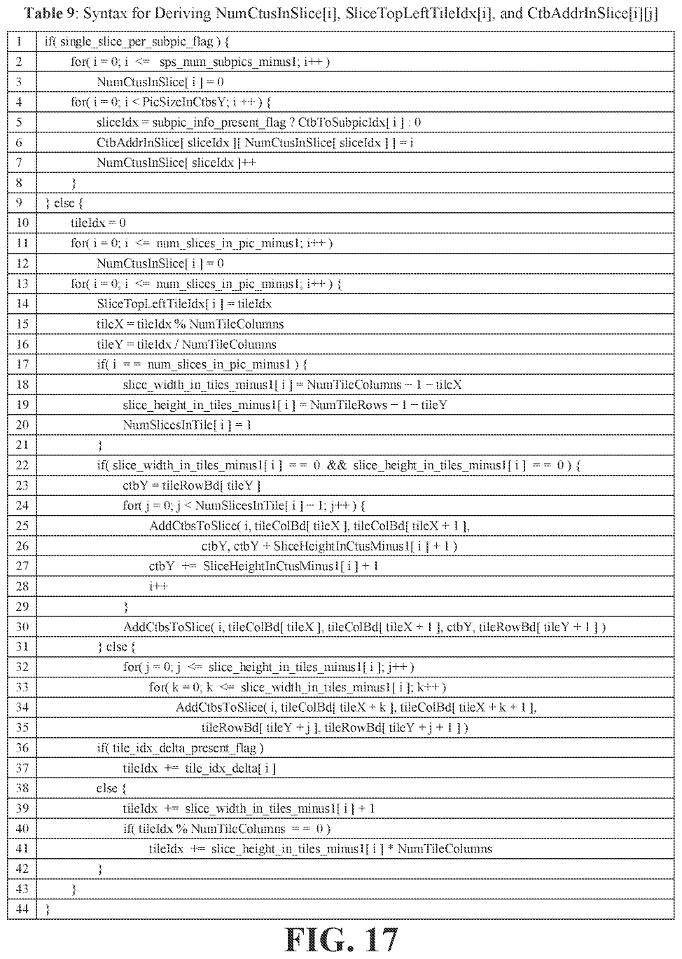

In VVC draft 8, for rectangular slices, the list “NumCtusInSlice[i]” (i being in an inclusive range from 0 to “num_slices_in_pic_minus1” in Table 1) that specifies the number of CTU in the i-th slice, the list “SliceTopLeftTileIdx[i]” in Table 1 (i being in an inclusive range from 0 to “num_slices_in_pic_minus1” in Table 1) that specifies the index of the top-left tile of the slice, and the matrix “CtbAddrInSlice[i][j]” (i being in an inclusive range from 0 to “num_slices_in_pic_minus1,” and j being in an inclusive range from 0 to “NumCtusInSlice[i]−1”) that specifies the picture raster scan address of the j-th CTB within the i-th slice can be derived in a manner illustrated in FIG. 17. FIG. 17 illustrates Table 9 of example syntax for deriving “NumCtusInSlice[i],” “SliceTopLeftTileIdx[i],” and “CtbAddrInSlice[i][j],” consistent with some embodiments of the disclosure. Table 9 includes 44 lines, as indicated by its leftmost column.

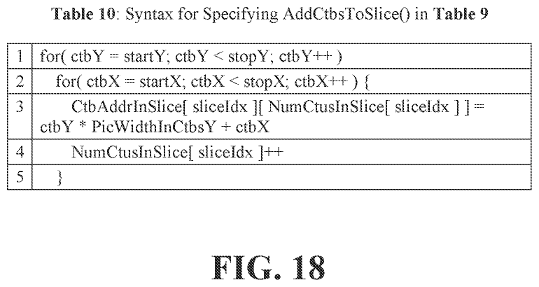

The function AddCtbsToSlice(sliceIdx, startX, stopX, startY, stopY) in Table 9 is specified in a manner illustrated in FIG. 18. FIG. 18 illustrates Table 10 of example syntax for specifying AddCtbsToSlice(sliceIdx, startX, stopX, startY, stopY), consistent with some embodiments of the disclosure. Table 10 includes 5 lines, as indicated by its leftmost column.

In VVC draft 8, it is a bitstream conformance requirement that the values of “NumCtusInSlice[i]” (i being in an inclusive range from 0 to “num_slices_in_pic_minus1.”) in Table 9 can be greater than 0. Additionally, it is a bitstream conformance requirement that the matrix “CtbAddrInSlice[i][j]” (i being in an inclusive range from 0 to “num_slices_in_pic_minus1,” and j being in an inclusive range from 0 to “NumCtusInSlice[i]−1”) in Table 9 can include all CTB addresses in the range 0 to “PicSizeInCtbsY−1” once and only once.

However, the above-described specifications in VVC Draft 8 can incur challenging problems. For example, although the value of “tile_column_width_minus1[i]” as shown and described in association with Table 1 is constrained to be in the inclusive range of 0 to “PicWidthInCthsY−1,” the “tile_column_width_minus1[i]+1” can be larger than the “PicWidthInCtbsY.” In another example, although the value of “tile_row_height_minus1[i]” as shown and described in association with Table 1 is constrained to be in the inclusive range of 0 to “PicHeightInCtbsY,” the “tile_row_height_minus1[i]+1” can be larger than the “PicHeightInCtbsY.” As another example, although the value of “exp_slice_height_in_ctus_minus1[j]” as shown and described in association with Table 1 is constrained in the inclusive range of 0 to “RowHeight[tileY]−1,” the “exp_slice_height_in_ctus_minus1[j]+1” can be larger than “RowHeight[tileY].” When any of the above example cases happens (i.e., the “tile_column_width_minus1[i]+1” being larger than “PicWidthInCtbsY,” the “tile_row_height_minus1[i]+1” being larger than the “PicHeightInCtbsY,” or the “exp_slice_height_in_ctus_minus1[j]+1” being larger than the “RowHeight[tileY]”), the CTB scanning order in a slice (e.g., represented by the array CtbAddrInSlice) and the number of CTBs in a slice (e.g., represented by the array NumCtusInSlice) can be incorrect.

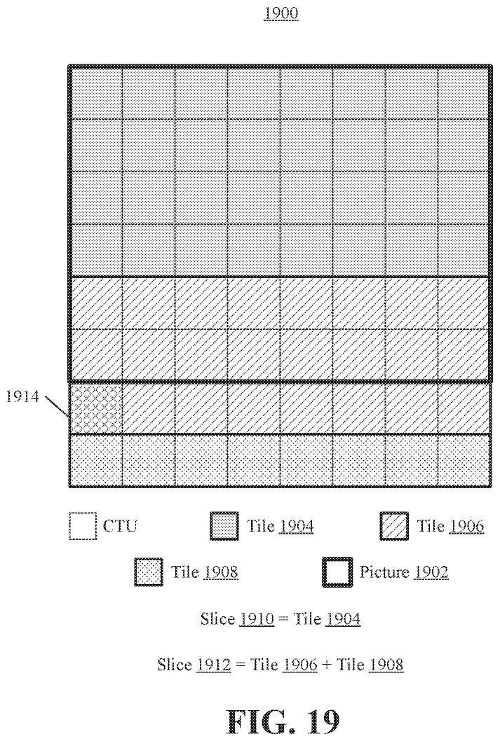

By way of example, FIG, 19 illustrates a tile map 1900 of a picture 1902, consistent with some embodiments of the disclosure. In FIG. 19, 19, each dotted-line square represents a CTU, and tile map 1900 is partitioned into 8×8 CTUs. The CTUs of tile map 1900 form three tiles 1904, 1906, and 1908, the scopes of which are represented by a gray, shaded, and dotted patterns as shown in FIG. 19, respectively. Tile 1904 includes 8×4 gray blocks, tile 1906 includes 8×3 shaded blocks, and tile 1908 includes 8×1 dotted blocks. Tiles 1904, 1906, and 1908 can be explicitly signaled in a PPS. Tile map 1900 includes two slices 1910 and 1912, in which tile 1904 forms slice 1910, and tiles 1906 and 1908 form slice 1912.

As illustrated in FIG. 19, a picture 1902 is partitioned into 8×6 CTUs, the boundary of which is represented by thicker solid lines. Tile map 1900 is larger than picture 1902. Tile map 1900 includes three tile rows and one tile column. A sum of heights of the tile rows (that includes tiles 1904, 1906, and 1908) is 8 CTUs, which is larger than a height of picture 1902 (i.e., 6 CTUs). Picture 1902 overlaps or covers two slices 1910 and 1912. Slice 1910 consists of tile 1904, and slice 1912 consists of tiles 1906 and 1908.

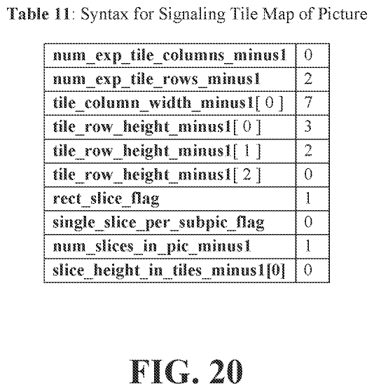

In some embodiments, syntax values in Table 1 of FIG. 9 related with tile map 1900 and picture 1902 can be signaled in a parameter set (e.g., a PPS) in a manner as illustrated in FIG. 20. FIG. 20 illustrates Table 11 of example syntax values for signaling a tile map of a picture, consistent with some embodiments of the disclosure.

With reference to FIG. 17, the function “AddCtbsToSlice( )” in Table 9 can be invoked with a tile boundary as an input for each tile in a slice to derive the matrix “CtbAddrInSlice[i][j]” in Table 9 that maps the CTU index j in slice i to CTU address in the picture. In such a case, with reference to FIG. 19, because tile 1906 covers an area outside picture 1902, incorrect CTB addresses can be added to the matrix “CtbAddrInSlice[i][j]” in Table 9. For example, as illustrated in FIG. 19, an address of a CTU 1914 (represented as a cross-shaded block in tile 1906) can be added to the matrix “CtbAddrInSlice[i][j].” However, CTU 1914 is outside picture 1902.

Adding CTU 1914 to the matrix “CtbAddrInSlice[i][j]” does not violate any constraints explicitly specified in VVC Draft 8. In VVC draft 8, the bitstream conformance only requires the matrix “CtbAddrInSlice” to cover all CTB addresses in a range from 0 to “PicSizeInCtbsY−1” once and only once. A CTB address outside the above range (e.g., CTB address with a value greater than or equal to PicSizeInCtbsY) can be allowed in “CtbAddrInSlice,” although such a CTB address is invalid. As discussed above, in existing technical solutions, a CTU address outside the picture is permitted to be included in “CtbAddrInSlice.” However, such an inclusion should be considered as an invalid case because a CTU outside a picture (i.e., not actually existing inside the picture) is added to a list of CTUs of a current slice to be encoded or decoded.

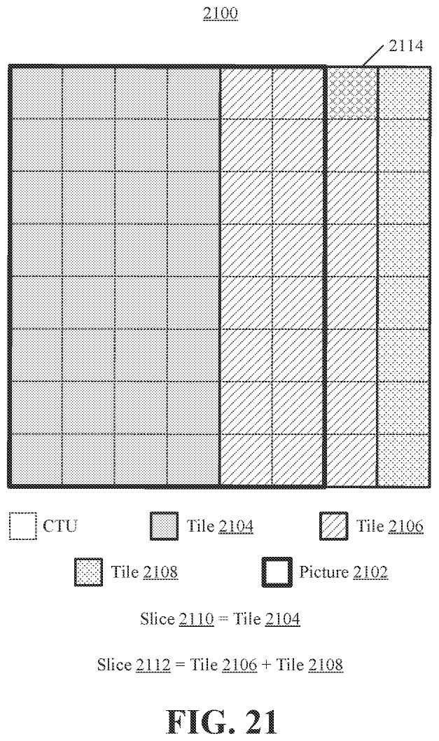

By way of example, FIG. 21 illustrates a tile map 2100 of a picture 2102, consistent with some embodiments of the disclosure. In FIG. 21, each dotted-line square represents a CTU, and tile map 2100 is partitioned into 8×8 CTUs. The CTUs of tile map 2100 form three tiles 2104, 2106, and 2108, the scopes of which are represented by a gray, shaded, and dotted patterns as shown in FIG. 21, respectively. Tile 2104 includes 4×8 gray blocks, tile 2106 includes 3×8 shaded blocks, and tile 2108 includes 1×8 dotted blocks. Tiles 2104, 2106, and 2108 can be explicitly signaled in a PPS. Tile map 2100 includes two slices 2110 and 2112, in which tile 2104 forms slice 2110, and tiles 2106 and 2108 form slice 2112.

As illustrated in FIG. 21, a picture 2102 is partitioned into 6×8 CTUs, the boundary of which is represented by thicker solid lines. Tile map 2100 is larger than picture 2102. Tile map 2100 includes three tile columns and one tile row. A sum of widths of the tile columns (that includes tiles 2104, 2106, and 2108) is 8 CTUs, which is larger than a width of picture 2102 (i.e., 6 CTUs). Picture 2102 overlaps or covers two slices 2110 and 2112., Slice 2110 consists of tile 2104, and slice 2112 consists of tiles 2106 and 2108.

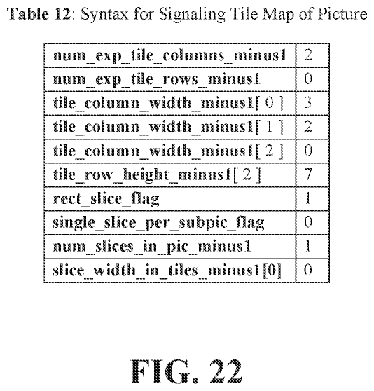

In some embodiments, syntax values in Table 1 of FIG. 9 related with tile map 2100 and picture 2102 can be signaled in a parameter set (e.g., a PPS) in a manner as illustrated in FIG. 22. FIG. 22 illustrates Table 12 of example syntax values for signaling a tile map of a picture, consistent with some embodiments of the disclosure.

With reference to FIG. 17, the function “AddCtbsToSlice( )” in Table 9 can be invoked with a tile boundary as an input for each tile in a slice to derive the matrix “CtbAddrInSlice[i][j]” in Table 9 that maps the CTU index j in slice i to CTU address in the picture. In such a case, with reference to FIG. 21, because tile 2106 covers an area outside picture 2102, incorrect CTB addresses can be added to the matrix “CtbAddrInSlice[i][j]” in Table 9. For example, as illustrated in FIG. 21, an address of a CTU 2114 (represented as a cross-shaded block in tile 2106) can be added to the matrix “CtbAddrInSlice[i][j].” However, based on AddCtbsToSlice( ), the CTU address of CTU 2114 in tile 2106 is mapped into tile 2104 because the address of a CTU typically wraps around a picture (e.g., picture 2102) once the CTU (e.g., CTU 2114) falls outside of a right boundary of the picture. Because the CTUs in tile 2104 have already been added to “CtbAddrInSlice[0],” such a wrapping behavior can cause violation of a bitstream conformance requirement as provided in VVC Draft 8. In VVC Draft 8, the bitstream conformance requirement includes that the matrix CtbAddrInSlice[i][j] (i being in an includsive range from 0 to num_slices_in_pic_minus1, and j being in an inclusive range from 0 to NumCtusInSlice[i]−1) includes all CTB addresses in the range from 0 to PicSizeInCtbsY−1 once and only once. The wrapping behavior associated with a CTU outside of a picture can violate the above-described bitstream conformance requirement because an address of a CTU (e.g., CTU 2114) in a tile (e.g., tile 2106) is included a list of CTUs (e.g., matrix “CtbAddrInSlice”) for more than once.

Besides the potential violation of actual violation of the constraints specified in VVC Draft 8 as described above in association with FIGS. 19-22, deciding whether a constraint (e.g., the bitstream conformance requirement as described herein) specified in VVC Draft 8 is violated can be a further technical problem. To avoid video coding errors, it is desirable to detect (e.g., via scanning) any violation of constraints (e.g., the violation of the bitstream conformance requirement as described herein) in the list of CTUs (e.g., the matrix “CtbAddrInSlice” in VVC Draft 8).

Embodiments of this disclosure provide methods and apparatuses for processing video content, being capable of detecting violations of constraints in the list of CTUs.

Consistent with some embodiments of this disclosure, the ensurance of the bitstream conformance requirement can be implemented with an additional bitstream constraint. In addition to the existing bitstream conformance requirement that “the matrix CtbAddrInSlice[i][j] (i being in an includsive range froth 0 to num_slices_in_pic_minus1, and j being in an inclusive range from 0 to NumCtusInSlice[i]−1) includes all CTB addresses in the range from 0 to PicSizeInCtbsY−1 once and only once,” such an additional bitstream constraint can be expressed as follows: “the value of ‘CtbAddrInSlice[i][j]’ (i being in an inclusive range from 0 to ‘num_slices_in_pic_minus1,’ and j being in an inclusive range from 0 to ‘NumCtusInSlice[i]−1’) is in an inclusive range of 0 to ‘PicSizeInCtbsY−1.’” Such an additional constraint can disregard or exclude any invalid CTB address from the array “CtbAddrInSlice.”

Consistent with some embodiments of this disclosure, the ensurance of the bitstream conformance requirement can be implemented by applying a modified process for deriving parameters in PPS syntax for signaling a tile map of a picture. With reference to FIGS. 9-18, the derivation of parameters “colWidth[i]” and “NumTileColumns” (as illustrated and described in association with FIG. 11), the derivation of parameters “RowHeight[j]” and “NumTileRows” for tile mapping (as illustrated and described in association with FIG. 12), and the derivation of parameters “SliceHeightInCtusMinus1[i+k]” and “NumSlicesInTile[i]” for rectangle slice in a tile mapping (as illustrated and described in association with FIG. 10) can be modified such that the sum of the derived colWidth[i] (i being in an inclusive range from 0 to “NumTileColumns−1”) is equal to the value of “PicWidthInCtbsY” as described herein, and the sum of RowHeight[j] (j being in an inclusive range from 0 to “NumTileRows−1”) is equal to the value of “PicHeightInCtbsY” as described herein.

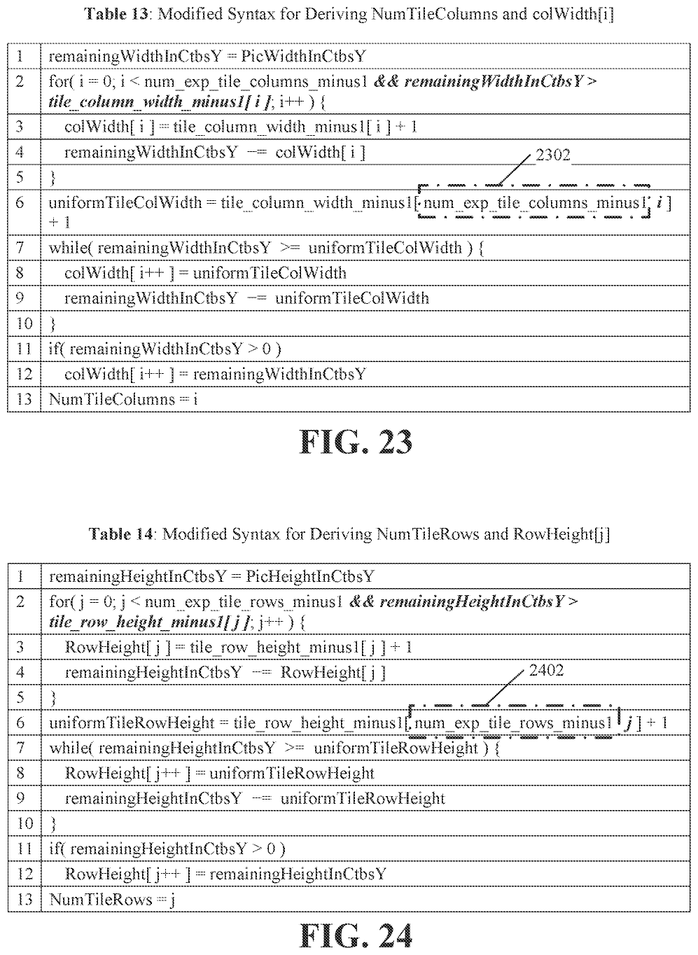

In some embodiments, the derivations of the above-described variables can be modified as follows. By way of example, the variable “NumTileColumns” that specifies the number of tile columns in Table 1 and the list “colWidth[i]” (i being in an inclusive range from 0 to “NumTileColumn−1”) that specifies the width of the i-th tile column in units of CTBs in Table 1 can be derived in a modified manner illustrated in FIG. 23. FIG. 23 illustrates Table 13 of example modified syntax for deriving “NumTileColums” and “colWidth[i]” in Table 1, consistent with some embodiments of the disclosure. Table 13 includes 13 lines, as indicated by its leftmost column.

FIG. 23 includes a dot-dash line box 2302 in line 6. In this disclosure, a dot-dash line box in the accompanying figures represents that the contents or elements enclosed therein are deleted or removed. FIG. 23 also includes italic-bold typeface for some texts in lines 2 and 6, In this disclosure, contents or elements shown in italic-bold typeface in the tables of the accompanying figures represents that they are added or inserted.

By way of example, the variable “NumTileRows” that specifies the number of tile rows in Table 1 and the list “RowHeight[j]” (j being in an inclusive range from 0 to “NumTileRows−1”) that specifies the height of the j-th tile row in units of CTBs in Table 1 can be derived in a modified manner illustrated in FIG. 24. FIG. 24 illustrates Table 14 of example modified syntax for deriving “NumTileRows” and “RowHeight[j]” in Table 1, consistent with some embodiments of the disclosure. Table 14 includes 13 lines, as indicated by its leftmost column. FIG. 24 includes a dot-dash line box 2402 in line 6 and italic-bold typeface for some texts in lines 2 and 6.

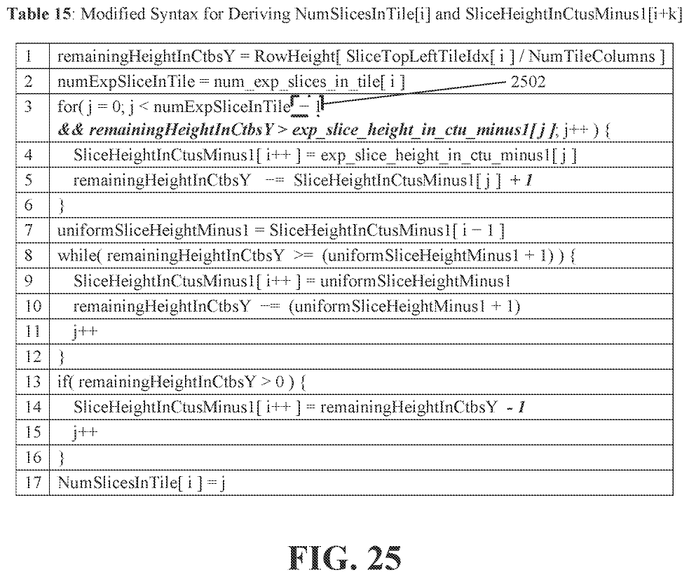

When “num_exp_slices_in_tile[i]” is greater than 0, the variables “NumSlicesInTile[i]” and “SliceHeightInCtusMinus1[i+k]” (k being in an inclusive range of 0 to “NumSlicesInTile[i]−1”) can be derived in a modified manner illustrated in FIG. 25. FIG. 25 illustrates Table 15 of example modified syntax for deriving “NumSlicesInTile[i]” and “SliceHeightInCtusMinus1[i+k]” when “num_exp_slices_in_tile[i]” is greater than 0, consistent with some embodiments of the disclosure. Table 15 includes 17 lines, as indicated by its leftmost column. FIG. 25 includes a dot-dash line box 2502 in line 3 and italic-bold typeface for some texts in lines 3, 5 (i.e., “+1”), and 14 (i.e., “−1”).

As illustrated in the embodiments described in association with FIGS. 23-25, when a sum of signaled “tile_column_width_minus1+1” is larger than a picture width, the derived sum of tile column widths can be clipped to the picture width, and a count of tile columns can be reduced to the count of tile columns within the picture (e.g., being less than or equal to the count of signaled tile columns). If there is a tile column beyond the right boundary of the picture, such a tile column can be ignored. Clipping a value, as used herein, can refer to an operation of setting the value to an upper limit value if the value exceeds the upper limit value or setting the value to a lower limit value if the value is below the lower limit value. By way of example, with reference to FIG. 21, where tile 2106 crosses the right boundary of picture 2102 and tile 2108 is outside picture 2102, the width of tile 2106 can be clipped down to 2 (e.g., in the unit of CTUs), and tile 2108 can be ignored.

As another example associated with FIGS. 23-25, when a sum of signaled “tile_row_height_minus1+1” is larger than the height of the picture, the derived sum of tile row heights can be clipped down to the picture height, and a count of tile rows can be reduced to the count of tile rows within the picture )e.g., being less than or equal to the count of signaled tile rows). If there is a tile row beyond the picture bottom boundary, such a row can be ignored. By way of example, with reference to FIG. 19, where tile 1906 crosses the bottom boundary of picture 1902 and tile 1908 is outside picture 1902, the height of tile 1906 can be clipped down to 2 (e.g., in the unit of CTUs), and tile 1908 can be ignored.

In another example associated with FIGS. 23-25, in a “slices in a tile” mapping, when a sum of signaled “exp_slice_height_in_ctus_minus1+1” is larger than the height of a tile, the sum of the slice height can be clipped to the tile bottom boundary, and the count of the slices can be reduced to the count of slices within the tile. Slices beyond the tile bottom boundary can be ignored.

In some embodiments, with reference to FIGS. 9-18, the derivation of parameters “colWidth[i]” and “NumTileColumns” (as illustrated and described in association with FIG. 11), the derivation of parameters “RowHeight[j]” and “NumTileRows” for tile mapping (as illustrated and described in association with FIG. 12), and the derivation of parameters “SliceHeightInCtusMinus1[i+k]” and “NumSlicesInTile[i]” for rectangle slice in a tile mapping (as illustrated and described in association with FIG. 10) can be modified as follows.

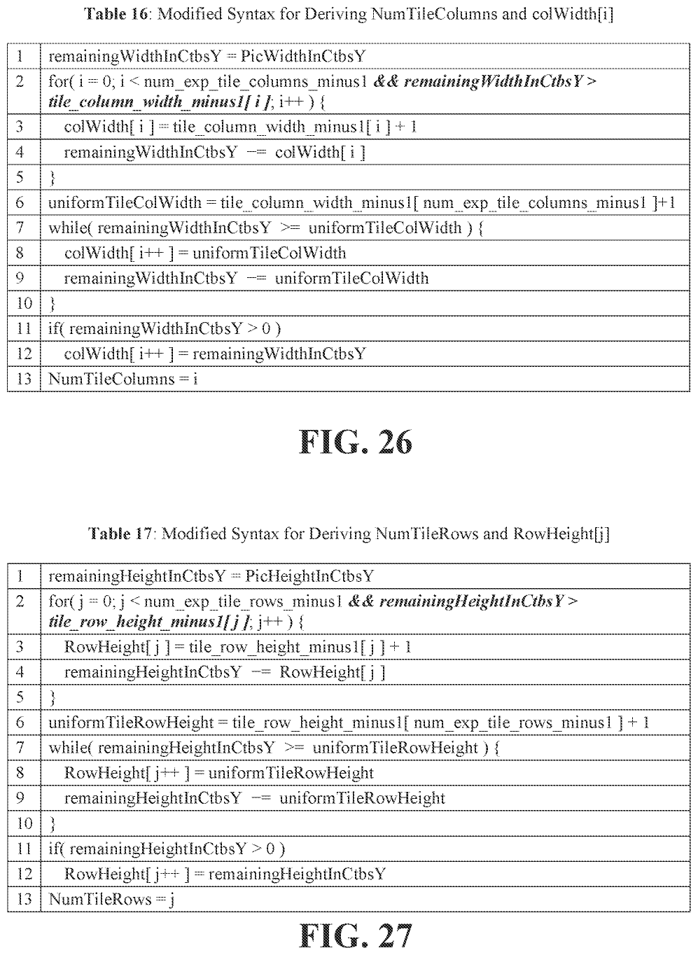

By way of example, the variable “NumTileColumns” that specifies the number of tile columns in Table 1 and the list “colWidth[i]” (i being in an inclusive range from 0 to “NumTileColumn−1”) that specifies the width of the i-th tile column in units of CTBs in Table 1 can be derived in a modified manner illustrated in FIG. 26. FIG. 26 illustrates Table 16 of another example modified syntax for deriving “NumTileColumns” and “colWidth[i]” in Table 1, consistent with some embodiments of the disclosure. Table 16 includes 13 lines, as indicated by its leftmost column. Compared with FIG. 23, FIG. 26 includes no dot-dash line box (e.g., no content is deleted) but includes italic-bold typeface for some texts in lines 2.

By way of example, the variable “NumTileRows” that specifies the number of tile rows in Table 1 and the list “RowHeight[j]” (j being in an inclusive range from 0 to “NumTileRows−1”) that specifies the height of the j-th tile row in units of CTBs in Table 1 can be derived in a modified manner illustrated in FIG. 27. FIG. 27 illustrates Table 17 of example modified syntax for deriving “NumTileRows” and “RowHeight[j]” in Table 1, consistent with some embodiments of the disclosure. Table 17 includes 13 lines, as indicated by its leftmost column. Compared with FIG. 24, FIG. 27 includes no dot-dash line box (e.g., no content is deleted) but includes italic-bold typeface for some texts in line 2.

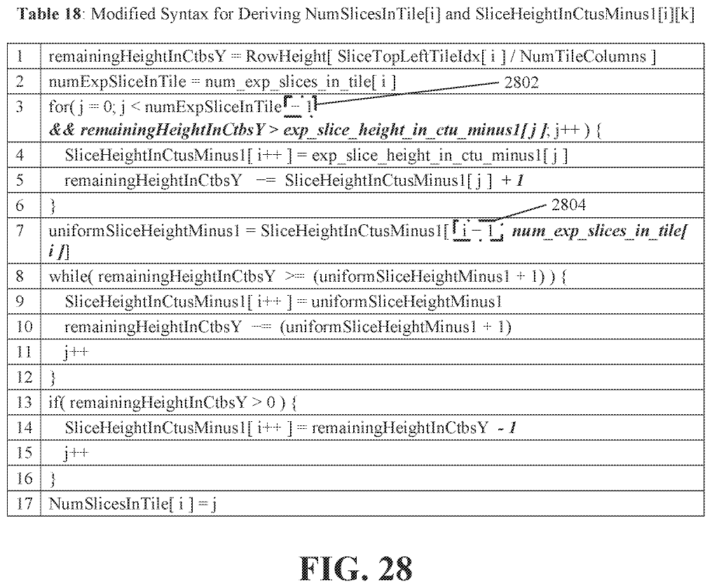

In association with FIGS. 26-27, when “num_exp_slices_in_tile[i]” is greater than 0, the variables “NumSlicesInTile[i]” and “SliceHeightInCtusMinus1[i+k]” (k being in an inclusive range of 0 to “NumSlicesInTile[i]−1”) can be derived in a modified manner illustrated in FIG. 28. FIG. 28 illustrates Table 18 of another example modified syntax for deriving “NumSlicesInTile[i]” and “SliceHeightInCtusMinus1[i+k]” when “num_exp_slices_in_tile[i]” is greater than 0, consistent with some embodiments of the disclosure. Table 18 includes 17 lines, as indicated by its leftmost column. FIG. 28 includes a dot-dash line box 2802 in line 3 and a dot-dash line box 2804 in line 7, as well as italic-bold typeface for some texts in lines 3, 5 (i.e., “+1”), 7, and 14 (i.e., “−1”).

The embodiments described in association with FIGS. 23-25 and the embodiments described in association with FIGS. 26-28 can apply different operations for handling situations when a tile crosses a boundary of a picture. For example, as illustrated in the embodiments described in association with FIGS. 26-28, when a tile is across the right boundary of the picture, the tile column width last signaled in the PPS can be repeatedly applied to fill the remaining width of the picture until the remaining width is smaller than the tile column last signaled, and then the tile column width last signaled can be clipped to be the remaining width. For example, with reference to FIG. 21, the width of the last-signaled tile column (e.g., tile 2108) is one. In such a case, a 1×8 tile column width can be repeatedly applied for twice to fill the remaining width, and picture 2102 can be partitioned into three tiles (not shown in FIG. 21) as a result, in which the first tile has a 4×8 tile column size (e.g., the same as tile 2104), the second tile has a 1×8 tile column size (e.g., adjusting tile 2106 to include the leftmost 1×8 tile column of shaded region), and the third tile also has a 1×8 tile column size (e.g., adjusting tile 2106 to include the middle 1×8 tile column of shaded region).

In another example, as illustrated in the embodiments described in association with FIGS. 26-28, when a tile is across the right boundary of the picture and the tile column width last signaled in the PPS is still larger than the remaining column width of the picture, the remaining column width of the picture can be treated as a tile by itself. In such a case, the condition of line 7 in Table 16 and Table 17 fails, and the derivation can directly go to line 11 in Table 16 and Table 17, respectively, in which cases all the remaining CTBs in the remaining column width of the picture form a tile by itself.

As another example associated with FIGS. 26-28, when a tile is across the bottom boundary of the picture, the tile row height last signaled in PPS can be repeatedly applied to fill the remaining height of the picture until the remaining height is smaller than the tile row height last signaled, and then the tile row height last signaled can be clipped to the remaining height. For example, in FIG. 19, the height of the last-signaled tile row (e.g., tile 1908) is one. In such a case, an 8×1 tile row height can be repeatedly applied for twice to fill the remaining height, and picture 1902 can be partitioned into three tiles (not shown in FIG. 19) as a result, in which the first tile has an 8×4 tile row size (e.g., the same as tile 1904), the second tile has an 8×1 tile row size different from tile 1906), and the third tile also has an 8×1 tile row size (e.g., different from tile 2106).

In the embodiments described in association with FIGS. 23-28, a CTU in a picture (e.g., a CTU address of the CTU from 0 to “PicSizeInCtbsY−1”) can be mapped to a slice once and only once. Also, it can be ensured that a CTU address is included in the matrix “CtbAddrInSlice[i][j]” once and only once and that no CTU address outside the picture area can be referred to in the matrix “CtbAddrInSlice[i][j].” By doing so, a bitstream conformance requirement can be maintained the same without adding any additional requirement (e.g., an additional requirement that “the value of “CtbAddrInSlice[i][j]” (i being in an inclusive range from 0 to “num_slices_in_pic_minus1,” and j being in an inclusive range from 0 to “NumCtusInSlice[i]−1) is in an inclusive range of 0 to ‘PicSizeInCtbsY−1’”), and the computation cost of an encoder or a non-compliant bitstream can be reduced.

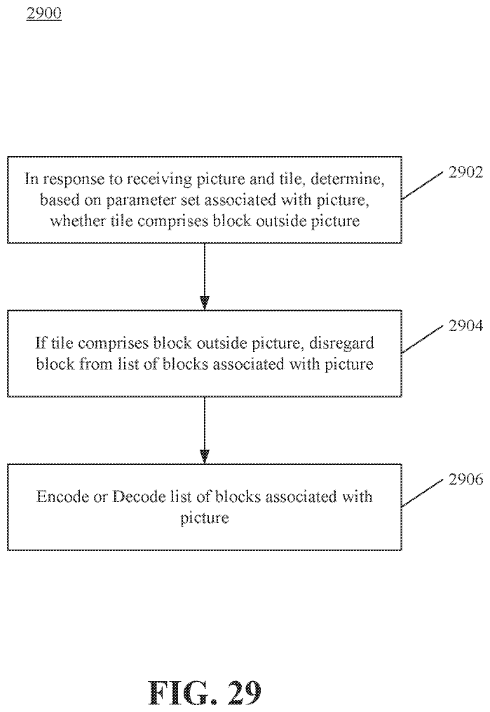

By way of example, FIG. 29 illustrates a flowchart of a process 2900 for video processing, according to some embodiments of this disclosure. In some embodiments, process 2900 can be performed by a codec (e.g., an encoder in FIGS. 2A-2B or a decoder in FIGS. 3A-3B). For example, the codec can be implemented as one or more software or hardware components of an apparatus (e.g., apparatus 400) for controlling a coding mode of encoding or decoding a video sequence, such as a processor (e.g., processor 402) of the apparatus.

At step 2902, in response to receiving a picture (e.g., picture 1902 in FIG. 19 or picture 2102 in FIG. 21) and a tile (e.g., tile 1904, 1906, or 1908 in FIG. 19 or tile 2104, 2106, or 2108 in FIG. 21), a processor (e.g., processor 402. in FIG. 4) can determine, based on a parameter set associated with the picture, whether the tile includes a block outside the picture. In sonic embodiments, the parameter set can be a picture parameter set (PPS). In some embodiments, the block can be a coding tree unit (CTU). By way of example, the block outside the picture can be CTU 1914 in in FIG. 19 or CTU 2114 in FIG. 21.

In some embodiments, to determine whether the tile includes the block outside the picture, the processor can determine whether adding a width (e.g., a column width that represents a horizontal span in the unit of blocks) of the tile to widths (e.g., the column widths described herein) of other tiles within the picture causes a first sum of the width and the widths to be greater than a width of the picture or whether adding a height (e.g., a row height that represents a vertical span in the unlit of blocks) of the tile (e.g., tile 1906 in FIG. 19) to heights (e.g., the row heights described herein) of the other tiles within the picture causes a second sum of the height and the heights to be greater than a height of the picture. The parameter set can include the width of the tile, the width of the picture, the height of the tile, and the height of the picture. Based on a determination that the first sum is greater than the width of the picture or a determination that the second sum is greater than the height of the picture, the processor can then determine that the tile includes the block outside the picture.

By way of example, with reference to FIG. 21, the tile can be tile 2106 and the other tiles can be tile 2104, and adding the width of tile 2106 (i.e., a column width of 3) to the width of tile 2104 a column width of 4) within picture 2102 causes the first sung (i.e., 7) to be greater than the width of picture 2102 (i.e., a width of 6), in which the processor can determine that tile 2106 includes the block (e.g., CTU 2114) outside picture 2102. In another example, with reference to FIG. 19, the tile can be tile 1906 and the other tiles can be tile 1904, and adding the height of tile 1906 (i.e., a row height of 3) to the height of tile 1904 (i.e., a row height of 4) within picture 1902 causes the second sum (i.e., 7) to be greater than the height of picture 1902 (i.e., a height of 6), in which the processor can determine that tile 1906 includes the block (e.g., CTU 1914) outside picture 1902.

At step 2904, based on a determination that the tile includes the block outside the picture, the processor can disregard the block from a list of blocks associated with the picture. For example, the list of blocks can be a list of blocks that are within the picture. The list of blocks can be in a form of an array or matrix (e.g., the matrix “CtbAddrInSlice” described in association with FIGS. 23-27).

In some embodiments, to disregard the block from the list of blocks associated with the picture, the processor can disable adding an address of the block to the list of blocks (e.g., the matrix “CtbAddrInSlice” described in association with FIGS. 23-27), in which the list of blocks includes addresses of blocks within a boundary of the picture. In some embodiments, the parameter set can include the boundary (e.g., a right boundary or a bottom boundary) of the picture and the addresses of the blocks within the boundary of the picture. For example, to disable adding the address of the block to the list of blocks, the processor can enforce a bitstream conformance requirement that specifies: “the value of ‘CtbAddrInSlice[i][j]’ (i being in an inclusive range from 0 to ‘num_slices_in_pic_minus1,’ and j being in an inclusive range from 0 to ‘NumCtusInSlice[i]−1’) is in an inclusive range of 0 to ‘PicSizeInCtbsY−1.’”

In some embodiments, to disregard the block from the list of blocks associated with the picture, the processor can adjust a size of the tile to cause the tile to include no block outside the picture. In some embodiments, to adjust the size of the tile, the processor can determine a width of the tile to be a remaining width associated with the picture, in which the remaining width can be a difference of a width of the picture subtracting a sum of widths of other tiles within the picture. In some embodiments, to adjust the size of the tile, the processor can determine a height of the tile to be a remaining height associated with the picture, wherein the remaining height is a difference of a height of the picture subtracting a sum of heights of the other tiles within the picture.

By way of example, with reference to FIG. 21, the processor can determine the remaining width as 2 by subtracting a sum of widths of other tiles (i.e., a sum width of 4 of tile 2104) within picture 2102 from the width of picture 2102 (i.e., a width of 6). In another example, with reference to FIG. 19, the processor can determine the remaining height as 2 by subtracting a sum of heights of other tiles (i.e., a sum height of 4 of tile 1904) within picture 1902 from the height of picture 1902 (i.e., a height of 6).

In some embodiments, to disregard the block from the list of blocks associated with the picture, the processor can determine a width or a height of a tile being last signaled in the parameter set. The picture can then partition the tile into columns having the width of the tile last signaled or into rows having the height of the tile last signaled. In response to a partitioned column or a partitioned row of the tile including a block outside the picture, the processor can adjust a width of the partitioned column or a height of the partitioned row to cause the partitioned column or the partitioned row to include no block outside the picture.

By way of example, with reference to FIG. 21, the tile can be tile 2106, and the tile being last signaled in the parameter set can be tile 2108. In such a case, the processor can determine the width of tile 2108 as 1. Then, the processor can partition tile 2106 into columns (e.g., three columns of size 1×8) having the width (i.e., 1) of tile 2108. In response to a partitioned column of the tile including a block outside the picture, the processor can adjust the width of the partitioned column to cause the partitioned column to include no block outside the picture. For example, in a case where the partitioned column of size 1×8 that includes CTU 2114 outside picture 2102, the processor can determine a width of the partitioned column to be the remaining width (e.g., 0) that is a difference of a width of picture 2102 (e.g., 6) subtracting a sum of widths of other tiles (e.g., a width of 4 of tile 2104) within picture 2102 and a sum of widths of other partitioned columns within picture 2102 (e.g., a sum width of 2 of the two partitioned columns of tile 2106 within picture 2102). If the width of the partitioned column is to be determined as 0, the partitioned column can be discarded.

By way of example, with reference to FIG. 19, the tile can be tile 1906, and the tile being last signaled in the parameter set can be tile 1908. In such a case, the processor can determine the height of tile 1908 as 1. Then, the processor can partition tile 1906 into rows (e.g., three rows of size 8×1) having the height (i.e., 1) of tile 1908. In response to a partitioned row of the tile including a block outside the picture, the processor can adjust the height of the partitioned row to cause the partitioned row to include no block outside the picture. For example, in a case where the partitioned row of size 8×1 that includes CTU 1914 outside picture 1902, the processor can determine a height of the partitioned row to be the remaining height (e.g., 0) that is a difference of a height of picture 1902 (e.g., 6) subtracting a sum of heights of other tiles (e.g., a height of 4 of tile 1904) within picture 1902 and a sum of heights of other partitioned rows within picture 1902 (e.g., a sum height of 2 of the two partitioned rows of tile 1906 within picture 1902). If the height of the partitioned row is determined as 0, the partitioned row can be discarded.

Still referring to FIG. 29, at step 2906, the processor can encode or decode the list of blocks associated with the picture. By way of example, with reference to FIG. 21, the list of blocks can include only blocks in tile 2104 and blocks in the left two columns of tile 2106. In another example, with reference to FIG. 19, the list of blocks can include only blocks in tile 1904 and blocks in the top two rows of tile 1906.

Consistent with some embodiments of this disclosure, the processor can further determine, based on the parameter set, whether the tile includes no block inside the picture. Based on a determination that the tile includes no block inside the picture, the processor can disregard all blocks of the tile from the list of blocks associated with the picture. By way of example, with reference to FIG. 21, if the tile is tile 2108 and the processor determines that tile 2108 includes no block inside picture 2102, the processor can disregard all blocks of tile 2108 from the list of blocks.

Consistent with some embodiments of this disclosure, the processor can further determine, based on the parameter set, whether the tile includes no block outside the picture. Based on a determination that the tile includes no block outside the picture, the processor can include all blocks of the tile into the list of blocks associated with the picture. By way of example, with reference to FIG. 19, if the tile is tile 1904 and the processor determines that tile 1904 includes no block outside picture 1902, the processor can include all blocks of tile 1904 into the list of blocks.

In some embodiments, a non-transitory computer-readable storage medium including instructions is also provided, and the instructions can be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device can include one or more processors (CPUs), an input/output interface, a network interface, and/or a memory.

The embodiments can further be described using the following clauses:
1. A non-transitory computer-readable medium storing a set of instructions that is executable by at least one processor of an apparatus to cause the apparatus to perform a method, the method comprising:
in response to receiving a picture and a tile, determining, based on a parameter set associated with the picture, whether the tile comprises a block outside the picture;
based on a determination that the tile comprises the block outside the picture, disregarding the block from a list of blocks associated with the picture; and
encoding or decoding the list of blocks associated with the picture,
2. The non-transitory computer-readable medium of clause 1, wherein determining, based on the parameter set associated with the picture, whether the tile comprises the block outside the picture comprises:
determining whether adding a width of the tile to widths of other tiles within the picture causes a first sum of the width and the widths to be greater than a width of the picture or whether adding a height of the tile to heights of the other tiles within the picture causes a second sum of the height and the heights to be greater than a height of the picture, wherein the parameter set comprises the width of the tile, the width of the picture, the height of the tile, and the height of the picture; and
based on a determination that the first sum is greater than the width of the picture or a determination that the second sum is greater than the height of the picture, determining that the tile comprises the block outside the picture.
3. The non-transitory computer-readable medium of clause 1, wherein disregarding the block from the list of blocks associated with the picture comprises:
disabling adding an address of the block to the list of blocks, wherein the list of blocks comprises addresses of blocks within a boundary of the picture.
4. The non-transitory computer-readable medium of clause 3, wherein the parameter set comprises the boundary of the picture and the addresses of the blocks within the boundary of the picture, and wherein the boundary of the picture comprise a right boundary or a bottom boundary.
5. The non-transitory computer-readable medium of clause 1, wherein disregarding the block from the list of blocks associated with the picture comprises:
adjusting a size of the tile to cause the tile to include no block outside the picture.
6. The non-transitory computer-readable medium of clause 5, wherein adjusting the size of the tile to cause the tile to include no block outside the picture comprises at least one of:
determining a width of the tile to be a remaining width associated with the picture, wherein the remaining width is a difference of a width of the picture subtracting a sum of widths of other tiles within the picture; or
determining a height of the tile to be a remaining height associated with the picture, wherein the remaining height is a difference of a height of the picture subtracting a sum of heights of the other tiles within the picture.
7. The non-transitory computer-readable medium of clause 5, wherein adjusting the size of the tile to cause the tile to include no block outside the picture comprises:
determining a width or a height of a last signaled tile in the parameter set;
partitioning the tile into columns haying the width of the last signaled tile or into rows having the height of the last signaled tile; and
in response to a partitioned column or a partitioned row of the tile comprising a block outside the picture, adjusting a width of the partitioned column or a height of the partitioned row to cause the partitioned column or the partitioned row to include no block outside the picture.
8. The non-transitory computer-readable medium of clause 1, wherein the set of instructions that is executable by the at least one processor of the apparatus causes the apparatus to further perform:
determining, based on the parameter set, whether the tile comprises no block inside the picture; and
based on a determination that the tile comprises no block inside the picture, disregarding all blocks of the tile from the list of blocks associated with the picture.
9. The non-transitory computer-readable medium of clause 1, wherein the set of instructions that is executable by the at least one processor of the apparatus causes the apparatus to further perform:
determining, based on the parameter set, whether the tile comprises no block outside the picture; and
based on a determination that the tile comprises no block outside the picture, including all blocks of the tile into the list of blocks associated with the picture.
10. The non-transitory computer-readable medium of any of clauses 1-9, wherein the parameter set is a picture parameter set.
11. The non-transitory computer-readable medium of any of clauses 1-9, wherein the block is a coding tree unit.
12. An apparatus, comprising:
a memory configured to store a set of instructions; and
one or more processors communicatively coupled to the memory and configured to execute the set of instructions to cause the apparatus to perform:
in response to receiving a picture and a tile, determining, based on a parameter set associated with the picture, whether the tile comprises a block outside the picture;
based on a determination that the tile comprises the block outside the picture, disregarding the block from a list of blocks associated with the picture; and
encoding or decoding the list of blocks associated with the picture.
13. The apparatus of clause 12, wherein determining, based on the parameter set associated with the picture, whether the tile comprises the block outside the picture comprises:
determining whether adding a width of the tile to widths of other tiles within the picture causes a first sum of the width and the widths to be greater than a width of the picture or whether adding a height of the tile to heights of the other tiles within the picture causes a second sum of the height and the heights to be greater than a height of the picture, wherein the parameter set comprises the width of the tile, the width of the picture, the height of the tile, and the height of the picture; and
based on a determination that the first sum is greater than the width of the picture or a determination that the second sum is greater than the height of the picture, determining that the tile comprises the block outside the picture.
14. The apparatus of clause 12, wherein disregarding the block from the list of blocks associated with the picture comprises:
disabling adding an address of the block to the list of blocks, wherein the list of blocks comprises addresses of blocks within boundary of the picture.
15. The apparatus of clause 14, wherein the parameter set comprises the boundary of the picture and the addresses of the blocks within the boundary of the picture, and wherein the boundary of the picture comprise a right boundary or a bottom boundary.
16. The apparatus of clause 12, wherein disregarding the block from the list of blocks associated with the picture comprises:
adjusting a size of the tile to cause the tile to include no block outside the picture.
17. The apparatus of clause 16, wherein adjusting the size of the tile to cause the tile to include no block outside the picture comprises at least one of:
determining a width of the tile to be a remaining width associated with the picture, wherein the remaining width is a difference of a width of the picture subtracting a sum of widths of other tiles within the picture; or
determining a height of the tile to be a remaining height associated with the picture, wherein the remaining height is a difference of a height of the picture subtracting a sum of heights of the other tiles within the picture.
18. The apparatus of clause 16, wherein adjusting the size of the tile to cause the tile to include no block outside the picture comprises:
determining a width or a height of a last signaled tile in the parameter set;
partitioning the tile into columns having the width of the last signaled tile or into rows having the height of the last signaled tile; and
in response to a partitioned column or a partitioned row of the tile comprising a block outside the picture, adjusting a width of the partitioned column or a height of the partitioned row to cause the partitioned column or the partitioned row to include no block outside the picture.
19. The apparatus of clause 12, wherein the one or more processors are further configured to execute the set of instructions to cause the apparatus to perform:
determining, based on the parameter set, whether the tile comprises no block inside the picture; and
based on a determination that the tile comprises no block inside the picture, disregarding all blocks of the tile from the list of blocks associated with the picture.
20. The apparatus of clause 12, wherein the one or more processors are further configured to execute the set of instructions to cause the apparatus to perform:
determining, based on the parameter set, whether the tile comprises no block outside the picture; and based on a determination that the tile comprises no block outside the picture, including all blocks of the tile into the list of blocks associated with the picture.
21. The apparatus of any of clauses 12-20, wherein the parameter set is a picture parameter set.
22. The apparatus of any of clauses 12-20, wherein the block is a coding tree unit.
23. A computer-implemented method, comprising:
in response to receiving a picture and a tile, determining, based on a parameter set associated with the picture, whether the tile comprises a block outside the picture;
based on a determination that the tile comprises the block outside the picture, disregarding the block from a list of blocks associated with the picture; and
encoding or decoding the list of blocks associated with the picture.
24. The computer-implemented method of clause 23, wherein determining, based on the parameter set associated with the picture, whether the tile comprises the block outside the picture comprises:
determining whether adding a width of the tile to widths of other tiles within the picture causes a first sum of the width and the widths to be greater than a width of the picture or whether adding a height of the tile to heights of the other tiles within the picture causes a second sum of the height and the heights to be greater than a height of the picture, wherein the parameter set comprises the width of the tile, the width of the picture, the height of the tile, and the height of the picture; and
based on a determination that the first sum is greater than the width of the picture or a determination that the second sum is greater than the height of the picture, determining that the tile comprises the block outside the picture.
25. The computer-implemented method of clause 23, wherein disregarding the block from the list of blocks associated with the picture comprises:
disabling adding an address of the block to the list of blocks, wherein the list of blocks comprises addresses of blocks within boundary of the picture.
26. The computer-implemented method of clause 25, wherein the parameter set comprises the boundary of the picture and the addresses of the blocks within the boundary of the picture, and wherein the boundary of the picture comprise a right boundary or a bottom boundary.
27. The computer-implemented method of clause 23, wherein disregarding the block from the list of blocks associated with the picture comprises:
adjusting a size of the tile to cause the tile to include no block outside the picture.
28. The computer-implemented method of clause 27, wherein adjusting the size of the tile to cause the tile to include no block outside the picture comprises at least one of:
determining a width of the tile to be a remaining width associated with the picture, wherein the remaining width is a difference of a width of the picture subtracting a sum of widths of other tiles within the picture; or
determining a height of the tile to be a remaining height associated with the picture, wherein the remaining height is a difference of a height of the picture subtracting a sum of heights of the other tiles within the picture.
29. The computer-implemented method of clause 27, wherein adjusting the size of the tile to cause the tile to include no block outside the picture comprises:
determining a width or a height of a last signaled tile in the parameter set;
partitioning the tile into columns haying the width of the last signaled tile or into rows having the height of the last signaled tile; and
in response to a partitioned column or a partitioned row of the tile comprising a block outside the picture, adjusting a width of the partitioned column or a height of the partitioned row to cause the partitioned column or the partitioned row to include no block outside the picture.
30. The computer-implemented method of clause 23, further comprising:
determining, based on the parameter set, whether the tile comprises no block inside the picture; and
based on a determination that the tile comprises no block inside the picture, disregarding all blocks of the tile from the list of blocks associated with the picture.
31. The computer-implemented method of clause 23, further comprising:
determining, based on the parameter set, whether the tile comprises no block outside the picture; and
based on a determination that the tile comprises no block outside the picture, including all blocks of the tile into the list of blocks associated with the picture.
32. The computer-implemented method of any of clauses 23-31, wherein the parameter set is a picture parameter set.
33. The computer-implemented method of any of clauses 23-31, wherein the block is a coding tree unit.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a component can include A or B, then, unless specifically stated otherwise or infeasible, the component can include A, or B, or A and B. As a second example, if it is stated that a component can include A, B, or C, then, unless specifically stated otherwise or infeasible, the component can include A, or B, or C, or A and B, or A and C, or B and C, or A and B and C.

It is appreciated that the above described embodiments can be implemented by hardware, or software (program codes), or a combination of hardware and software. If implemented by software, it can be stored in the above-described computer-readable media. The software, when executed by the processor can perform the disclosed methods. The computing units and other functional units described in the present disclosure can be implemented by hardware, or software, or a combination of hardware and software. One of ordinary skill in the art can also understand that multiple ones of the above described modules/units can be combined as one module/unit, and each of the above described modules/units can be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is intended that the specification and examples be considered as example only, with a true scope and spirit of the disclosure being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed example embodiments. However, many variations and modifications can be made to these embodiments. Accordingly, although specific terms are employed, they are used in a generic and descriptive sense only and not for purposes of limitation.

What is claimed is:

1. A non-transitory computer-readable medium storing a set of instructions that is executable by at least one processor of an apparatus to cause the apparatus to perform a method, the method comprising:
in response to receiving a picture and a tile, determining, based on a parameter set associated with the picture, whether the tile comprises a block outside the picture;
based on a determination that the tile comprises the block outside the picture, disregarding the block from a list of blocks associated with the picture; and
encoding or decoding the list of blocks associated with the picture.

2. The non-transitory computer-readable medium of claim 1, wherein determining, based on the parameter set associated with the picture, whether the tile comprises the block outside the picture comprises:
determining whether adding a width of the tile to widths of other tiles within the picture causes a first sum of the width and the widths to be greater than a width of the picture or whether adding a height of the tile to heights of the other tiles within the picture causes a second sum of the height and the heights to be greater than a height of the picture, wherein the parameter set comprises the width of the tile, the width of the picture, the height of the tile, and the height of the picture; and
based on a determination that the first sum is greater than the width of the picture or a determination that the second sum is greater than the height of the picture, determining that the tile comprises the block outside the picture.

3. The non-transitory computer-readable medium of claim 1, wherein disregarding the block from the list of blocks associated with the picture comprises:
disabling adding an address of the block to the list of blocks, wherein the list of blocks comprises addresses of blocks within a boundary of the picture.

4. The non-transitory computer-readable medium of claim 3, wherein the parameter set comprises the boundary of the picture and the addresses of the blocks within the boundary of the picture, and wherein the boundary of the picture comprise a right boundary or a bottom boundary.

5. The non-transitory computer-readable medium of claim 1, wherein disregarding the block from the list of blocks associated with the picture comprises:
adjusting a size of the tile to cause the tile to include no block outside the picture.

6. The non-transitory computer-readable medium of claim 5, wherein adjusting the size of the tile to cause the tile to include no block outside the picture comprises at least one of:
determining a width of the tile to be a remaining width associated with the picture, wherein the remaining width is a difference of a width of the picture subtracting a sum of widths of other tiles within the picture; or
determining a height of the tile to be a remaining height associated with the picture, wherein the remaining height is a difference of a height of the picture subtracting a sum of heights of the other tiles within the picture.

7. The non-transitory computer-readable medium of claim 5, wherein adjusting the size of the tile to cause the tile to include no block outside the picture comprises:
determining a width or a height of a last signaled tile in the parameter set;
partitioning the tile into columns haying the width of the last signaled tile or into rows having the height of the last signaled tile; and
in response to a partitioned column or a partitioned row of the tile comprising a block outside the picture, adjusting a width of the partitioned column or a height of the partitioned row to cause the partitioned column or the partitioned row to include no block outside the picture.

8. The non-transitory computer-readable medium of claim 1, wherein the set of instructions that is executable by the at least one processor of the apparatus causes the apparatus to further perform:
determining, based on the parameter set, whether the tile comprises no block inside the picture; and
based on a determination that the tile comprises no block inside the picture, disregarding all blocks of the tile from the list of blocks associated with the picture.

9. The non-transitory computer-readable medium of claim 1, wherein the set of instructions that is executable by the at least one processor of the apparatus causes the apparatus to further perform:
determining, based on the parameter set, whether the tile comprises no block outside the picture; and
based on a determination that the tile comprises no block outside the picture, including all blocks of the tile into the list of blocks associated with the picture.

10. The non-transitory computer-readable medium of claim 1, wherein the parameter set is a picture parameter set.

11. The non-transitory computer-readable medium of any of claim 1, wherein the block is a coding tree unit.

12. An apparatus, comprising:
a memory configured to store a set of instructions; and
one or more processors communicatively coupled to the memory and configured to execute the set of instructions to cause the apparatus to perform:
in response to receiving a picture and a tile, determining, based on a parameter set associated with the picture, whether the tile comprises a block outside the picture;
based on a determination that the tile comprises the block outside the picture, disregarding the block from a list of blocks associated with the picture; and
encoding or decoding the list of blocks associated with the picture.

13. The apparatus of claim 12, wherein determining, based on the parameter set associated with the picture, whether the tile comprises the block outside the picture comprises:
determining whether adding a width of the tile to widths of other tiles within the picture causes a first sum of the width and the widths to be greater than a width of the picture or whether adding a height of the tile to heights of the other tiles within the picture causes a second sum of the height and the heights to be greater than a height of the picture, wherein the parameter set comprises the width of the tile, the width of the picture, the height of the tile, and the height of the picture; and
based on a determination that the first sum is greater than the width of the picture or a determination that the second sum is greater than the height of the picture, determining that the tile comprises the block outside the picture.

14. The apparatus of claim 12, wherein disregarding the block from the list of blocks associated with the picture comprises:
disabling adding an address of the block to the list of blocks, wherein the list of blocks comprises addresses of blocks within boundary of the picture.

15. The apparatus of claim 14, wherein the parameter set comprises the boundary of the picture and the addresses of the blocks within the boundary of the picture, and wherein the boundary of the picture comprise a right boundary or a bottom boundary.

16. The apparatus of claim 12, wherein disregarding the block from the list of blocks associated with the picture comprises:
adjusting a size of the tile to cause the file to include no block outside the picture.

17. The apparatus of claim 16, wherein adjusting the size of the tile to cause the tile to include no block outside the picture comprises at least one of:
determining a width of the tile to be a remaining width associated with the picture, wherein the remaining width is a difference of a width of the picture subtracting a sum of widths of other tiles within the picture; or
determining a height of the tile to be a remaining height associated with the picture, wherein the remaining height is a difference of a height of the picture subtracting a sum of heights of the other tiles within the picture.

18. The apparatus of claim 16, wherein adjusting the size of the tile to cause the tile to include no block outside the picture comprises:
determining a width or a height of a last signaled tile in the parameter set;
partitioning the tile into columns having the width of the last signaled tile or into rows having the height of the last signaled tile; and
in response to a partitioned column or a partitioned row of the tile comprising a block outside the picture, adjusting a width of the partitioned column or a height of the partitioned row to cause the partitioned column or the partitioned row to include no block outside the picture.

19. The apparatus of claim 12, wherein the one or more processors are further configured to execute the set of instructions to cause the apparatus to perform:
determining, based on the parameter set, whether the tile comprises no block inside the picture; and
based on a determination that the tile comprises no block inside the picture, disregarding all blocks of the tile from the list of blocks associated with the picture.

20. A computer-implemented method, comprising:
in response to receiving a picture and a tile, determining, based on a parameter set associated with the picture, whether the tile comprises a block outside the picture;
based on a determination that the tile comprises the block outside the picture, disregarding the block from a list of blocks associated with the picture; and
encoding or decoding the list of blocks associated with the picture.
